(19) United States
(12) Patent Application Publication
(10) Pub. No.: US 2022/0321018 A1
(43) Pub. Date: Oct. 6, 2022

(54) SWITCHING POWER SUPPLY CIRCUIT

(71) Applicant: Rohm Co., Ltd., Kyoto (JP)

(72) Inventor: Yusuke NAKAKOHARA, Kyoto (JP)

(21) Appl. No.: 17/763,841

(22) PCT Filed: May 18, 2020
(86) PCT No.: PCT/JP2020/019572

§ 371 Date: Mar. 25, 2022

(30) Foreign Application Priority Data
Sep. 25, 2019 (JP) 2019 174084

(51) Int. Cl. H02M 3/335; H02M 1/08; H02M 1/00; H02M 1/32

(52) U.S. Cl. CPC H02M 3/33576; H02M 1/08; H02M 1/0009; H02M 1/327

(57) ABSTRACT

A switching power supply circuit (100XA) includes switching elements (SW31 and SW41), a detector (310) configured to detect a physical quantity (Tout) related to the output power of the switching power supply circuit, and a variable controller (42) configured to variably control the gate driving voltages (G3 and G4) for the switching elements based on the result (Idet) of detection by the detector.

### TECHNICAL FIELD

The present invention relates to switching power supply circuits.

### BACKGROUND ART

A variety of switching power supply circuits are known today, of which one example is seen in Patent Document 1 identified below.

The switching power supply circuit of Patent Document 1 is a multi-phase DC-DC converter that is configured to switch the number of operating phases according to the output power, with a view to achieving high efficiency according to the output power.

### CITATION LIST

### Patent Literature

Patent Document 1: Japanese unexamined patent application publication No. 2007-116834

### SUMMARY OF INVENTION

### Technical Problem

Inconveniently, with a scheme like the one employed in Patent Document 1 mentioned above which switches the number of operating phases, if the configuration is such that, even when a transistor for an unused phase is kept constantly off, a current passes through the body diode of that transistor, there may occur in the body diode a diode loss that is greater than the conduction loss ascribable to the on-state resistance of a transistor in the on state, leading to a drop in efficiency. In particular, in applications where a high current passes through a transistor, the drop in efficiency may be greater. Moreover, the scheme disclosed in Patent Document 1 mentioned above is applicable solely to multi-phase DC-DC converters, not to single-phase DC-DC converters.

In view of the circumstances mentioned above, an object of the present invention is to provide a switching power supply circuit that offers high efficiency over a wide output power range.

### Solution to Problem

According to one aspect of the present invention, a switching power supply circuit includes: a switching element; a detector configured to detect a physical quantity related to the output power of the switching power supply circuit; and a variable controller configured to variably control the gate driving voltage for the switching element based on the result of detection by the detector. (A first configuration.)

In the first configuration described above, the detector may be a current detector configured to detect as the physical quantity the output current passing from the switching power supply circuit to a load. (A second configuration.)

In the first configuration described above, the detector may a current detector configured to detect as the physical quantity the current passing through the switching element. (A third configuration.)

In the second or third configuration described above, the variable controller may include: a reference voltage generator configured to generate a reference voltage based on a current detection signal output from the current detector; and a regulator configured to output based on the reference voltage an output voltage used as the gate driving voltage. (A fourth configuration.)

In the fourth configuration described above, the reference voltage generator may include voltage division resistors configured to divide the voltage of the current detection signal. (A fifth configuration.)

In the fourth or fifth configuration described above, the reference voltage generator may include: a first resistor having a first terminal fed with the current detection signal; and a first capacitor having a first terminal connected to a second terminal of the first resistor and a second terminal fed with a ground potential. (A sixth configuration.)

In any of the fourth to sixth configurations described above, the regulator may include: an output transistor having a first terminal fed with an input voltage and a second terminal at which the output voltage appears; a second resistor having a first terminal connected to the second terminal of the output transistor; a third resistor having a first terminal connected to a second terminal of the second resistor and a second terminal fed with a ground potential; and a first error amplifier having a first input terminal connected to a connection node to which the second and third resistors are connected, a second input terminal fed with the reference voltage, and an output terminal connected to a control terminal of the output transistor. (A seventh configuration.)

In any of the fourth to seventh configurations described above, there may be further provided: a push-pull circuit configured to be supplied with the output voltage as the supply voltage, to be fed with the output of a driver, and to output the gate driving voltage while switching its levels based on the output of the driver. (An eighth configuration.)

In the first configuration described above, the detector may be a temperature detector configured to detect as the physical quantity the temperature of the switching element. (A ninth configuration.)

In the ninth configuration described above, the variable controller may include: a processor configured to calculate the conduction loss in the switching element based on a temperature detection signal output from the detector and the gate driving voltage. (A tenth configuration.)

In any of the first to tenth configurations described above, the switching power supply circuit may be of an isolated type, and the switching element may arranged in the secondary side. (An eleventh configuration.)

In the eleventh configuration described above, there may be provided: a first input capacitor and a second input capacitor connected in series between an application terminal for a first input voltage and an application terminal for a ground potential; a first switching element and a second switching element connected in series between the application terminal for the first input voltage and the application terminal for the ground potential; a transformer having a primary winding connected between a first connection node to which the first and second input capacitors are connected and a second connection node to which the first and second switching elements are connected, and a secondary winding; a first inductor having a first terminal connected to a first terminal of the secondary winding; a second inductor having a first terminal connected to a second terminal of the secondary winding; a third switching element having a first terminal connected to the first terminal of the second inductor; a fourth switching element having a first terminal connected to the first terminal of the first inductor; and an output capacitor having a first terminal connected to a third connection node to which the second terminals of the first and second inductors are connected, and a second terminal connected to the second terminals of the third and fourth switching elements. (A twelfth configuration.)

In the twelfth configuration described above, there may be provided a plurality of secondary-side circuits each including the secondary winding, the first and second inductors, and the third and fourth switching elements, and the plurality of secondary-side circuits may be connected in parallel. (A thirteenth configuration.)

In the twelfth or thirteenth configuration described above, the detector may be a current detector arranged in the stage succeeding to the output capacitor. (A fourteenth configuration.)

In the twelfth or thirteenth configuration described above, the detector may be a current detector configured to detect the current through each of the third and fourth switching elements. (A fifteenth configuration.)

In the thirteenth configuration described above, the detector may include a current detector for each of the secondary-side circuits. (A sixteenth configuration.)

In the sixteenth configuration described above, the current detector may be arranged in the stage succeeding the third connection node. The variable controller may include: a reference voltage generator configured to generate a reference voltage based on a current detection signal output from the current detector; and a regulator configured to output based on the reference voltage an output voltage used as the gate driving voltage. The reference voltage generator may include: a first resistor having a first terminal fed with the current detection signal; and a first capacitor having a first terminal connected to a second terminal of the first resistor and a second terminal fed with a ground potential. (A seventeenth configuration.)

In the twelfth or thirteenth configuration described above, the detector may be a temperature detector configured to detect the temperature of each of the third and fourth switching elements. (A eighteenth configuration.)

In any of the twelfth to eighteenth configurations described above, the first, second, third, and fourth switching elements may be formed by use of GaN (gallium nitride) as a semiconductor material. (A nineteenth configuration.)

### Advantageous Effects of Invention

According to the present invention, it is possible to provide a switching power supply circuit that offers high efficiency over a wide output power range.

### BRIEF DESCRIPTION OF DRAWINGS

FIG. 1 is a circuit diagram of a switching power supply circuit as a study circuit;

FIG. 2 is a diagram showing the operation state of a switching power supply circuit in mode A;

FIG. 3 is a diagram showing the operation state of a switching power supply circuit in mode B;

FIG. 4 is a diagram showing the operation state of a switching power supply circuit in mode C;

FIG. 5 is a diagram showing the operation state of a switching power supply circuit in mode D;

FIG. 6 is a timing chart showing one example of the operation of a switching power supply circuit;

FIG. 7 is a circuit diagram of a switching power supply circuit having secondary circuits connected in parallel;

FIG. 8 is a chart showing one example of the relationship of gate driving voltage Vgs with gate driving loss Pgt loss;

FIG. 9 is a chart showing one example of the relationship of gate driving voltage Vgs with on-state resistance Rdson with respect to a secondary-side switching element;

FIG. 10 is a chart showing one example of the relationship of output power with efficiency as observed as the gate driving voltage Vgs for a secondary-side switching element is varied;

FIG. 11 is a chart showing one example of the relationship of output power with efficiency as observed when the gate driving voltage Vgs for a secondary-side switching element is variably controlled and when it is kept constant;

FIG. 12 is a circuit diagram showing the configuration of a switching power supply circuit according to a first embodiment;

FIG. 13 is a circuit diagram showing a configuration related to feedback control and gate driving voltage variable control in the switching power supply circuit according to the first embodiment;

FIG. 14 is a circuit diagram showing the configuration of a switching power supply circuit according to a second embodiment;

FIG. 15 is a circuit diagram showing a configuration related to feedback control and gate driving voltage variable control in the switching power supply circuit according to the second embodiment;

FIG. 16 is a circuit diagram showing the configuration of a switching power supply circuit according to a third embodiment;

FIG. 17 is a circuit diagram showing a configuration related to feedback control and gate driving voltage variable control in the switching power supply circuit according to the third embodiment;

FIG. 18 is a circuit diagram showing the configuration of a switching power supply circuit according to one modified example of the third embodiment;

FIG. 19 is a circuit diagram showing the configuration of a switching power supply circuit according to a fourth embodiment;

FIG. 20 is a circuit diagram showing a configuration related to feedback control and gate driving voltage variable control in the switching power supply circuit according to the fourth embodiment;

FIG. 21A is a schematic plan view of one example of the layout of a switching power supply circuit on a printed circuit board, as seen from the obverse side;

FIG. 21B is a schematic plan view of one example of the layout of a switching power supply circuit on a printed circuit board, as seen from the reverse side;

FIG. 22 is a schematic diagram showing one example of a transformer formed with a conductor pattern;

FIG. 23 is a perspective view of a semiconductor device; and

FIG. 24 is a plan view of a transistor in the semiconductor device shown in FIG. 23.

### DESCRIPTION OF EMBODIMENTS

Hereinafter, some embodiments of the present invention will be described with reference to the accompanying drawings.

### 1. Configuration of a Study Circuit

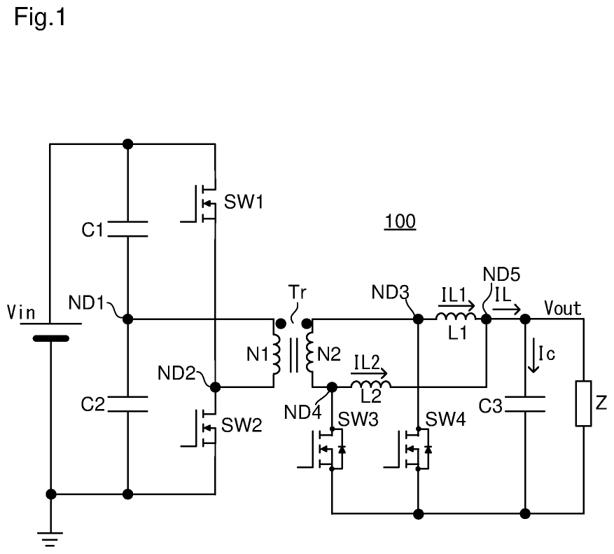

First, the switching power supply circuit that the prevent inventor studied will be described. FIG. 1 is a circuit diagram of the switching power supply circuit 100 that the prevent inventor studied. The switching power supply circuit 100 is an isolated half-bridge interleaving drive circuit.

As shown in FIG. 1, the switching power supply circuit 100 includes input capacitors C1 and C2, primary-side switching elements SW1 and SW2, a transformer Tr, secondary-side switching elements SW3 and SW4, inductors L1 and L2, and an output capacitor C3.

The input capacitors C1 and C2 are connected in series between an application terminal for an input voltage Vin, which is a direct-current voltage, and an application terminal for a ground potential. Specifically, to the first terminal of the input capacitor C1, the application terminal for the input voltage Vin is connected, and the second terminal of the input capacitor C1 is connected to the first terminal of the input capacitor C2 at a connection node ND1. The second terminal of the input capacitor C2 is connected to the application terminal for the ground potential.

The switching elements SW1 and SW2 are configured as n-channel MOSFETs (metal-oxide-semiconductor field-effect transistors). The drain of the switching element SW1 is connected to the first terminal of the input capacitor C1. The source of the switching element SW1 is connected to the drain of the switching element SW2 at a connection node ND2. The source of the switching element SW2 is connected to the application terminal for the ground potential. That is, the switching elements SW1 and SW2 are connected in series between the application terminal for the input voltage Vin and the application terminal for the ground potential to constitute a half-bridge.

Between the connection nodes ND1 and ND2, the primary winding N1 of the transformer Tr is connected. The first terminal of the secondary winding N2 of the transformer Tr is connected to the first terminal of the inductor L1 at a connection node ND3. The second terminal of the secondary winding N2 is connected to the first terminal of the inductor L2 at a connection node ND4. The second terminal of the inductor L1 is connected to the second terminal of the inductor L2 at a connection node ND5.

To the connection node ND5, the first terminal of the output capacitor C3 is connected. The switching elements SW3 and SW4 are secondary-side synchronous rectification transistors, and are configured as n-channel MOSFETs. The drain of the switching element SW3 is connected to the connection node ND4. The drain of the switching element SW4 is connected to the connection node ND3. The sources of the switching elements SW3 and SW4 are connected to the second terminal of the output capacitor C3.

Between the terminals of the output capacitor C3, a load Z is connected. Through the switching control (turning on and off) of the switching elements SW1 to SW4, the input voltage Vin is converted to an output voltage Vout, which is a direct-current voltage. The output voltage Vout appears at the first terminal of the output capacitor C3, and is supplied to the load Z.

### 2. Features of the Study Circuit

The switching power supply circuit 100 described above as the study circuit has the following features. First, in the switching power supply circuit 100, used as the switching elements SW1 to SW4 are transistors that use GaN (gallium nitride) as a semiconductor material. This permits high-frequency driving of switching elements, allowing them to be driven, for example, at 5 MHz. High-frequency driving of switching elements contributes to achieving size reduction in passive components.

The primary-side switching elements SW1 and SW2 are subjected to hard switching. Hard switching causes switching loss; however, compared with transistors using Si as a semiconductor material, transistors using GaN as a semiconductor material have lower parasitic capacitances, and this helps keep switching loss small, leading to a notable reduction in switching loss in high-frequency driving. Incidentally, the secondary-side switching elements SW3 and SW4 are subjected to soft switching, and thus cause almost zero switching loss.

As withstand voltage rises, the difference in parasitic capacitance between transistors using Si as a semiconductor material and those using GaN increases. Since the switching elements SW1 and SW2 used in the primary side have a high withstand voltage, using GaN as a semiconductor material for the switching elements SW1 and SW2 is very effective. For example, the switching elements SW1 and SW2 have a withstand voltage of 100 V.

The switching power supply circuit 100 is compatible with, as the input voltage Vin, worldwide voltages, for example, 36 V to 75 V. A regulation exists that requires isolation for an input voltage Vin of 60 V or higher. Accordingly, the switching power supply circuit 100 achieves isolation by use of the transformer Tr. Moreover, to reduce loss in the transformer, the switching power supply circuit 100 uses a coreless transformer as the transformer Tr.

The switching power supply circuit 100 is used, for example, with the input voltage Vin=48 V and the output voltage Vout=1 V.

Owing to the half-bridge configuration, the switching power supply circuit 100 only needs one half of the number of turns in the primary winding of the transformer Tr compared with the full-bridge configuration, and this helps reduce transformer loss.

Configured as a single-stage converter, the switching power supply circuit 100 offers high efficiency.

The switching power supply circuit 100 performs interleaving driving, driving the secondary-side switching elements SW3 and SW4 with shifted phases. This helps reduce ripples in the current through the output capacitor C3, and thus helps reduce the size of the output capacitor C3. Interleaving driving will be described in detail later.

The switching power supply circuit 100 performs duty control, and this helps stabilize the output voltage Vout easily. Duty control will be described in detail later.

### 3. Operation of the Study Circuit

Next, the operation of the switching power supply circuit 100 studied will be described. The switching power supply circuit 100 operates in one of four modes, namely modes A, B, C, and D.

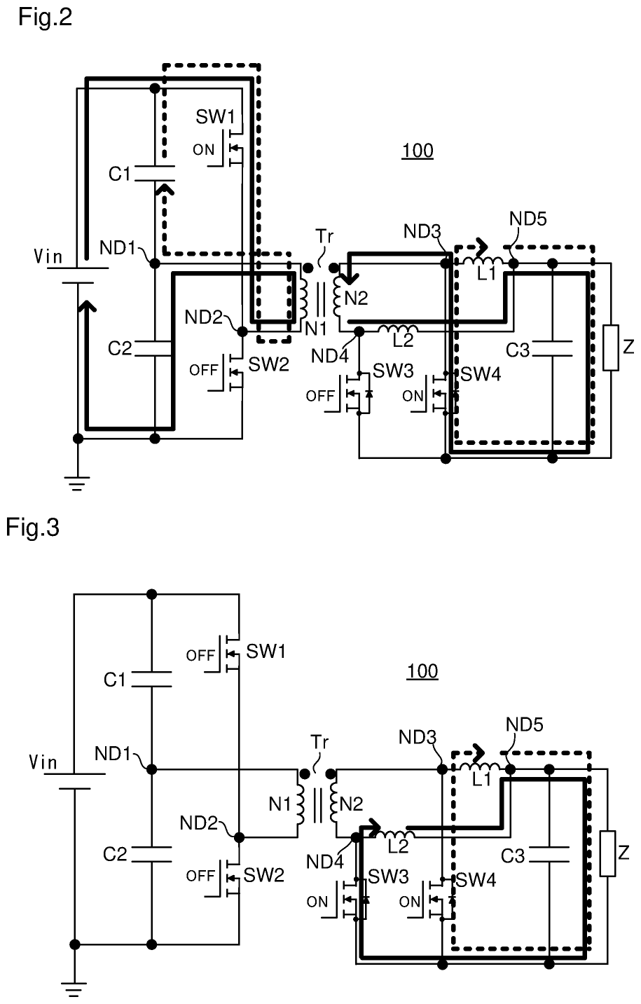

FIG. 2 is a diagram showing the operation state of the switching power supply circuit 100 in mode A. As shown in FIG. 2, in mode A, the switching element SW1 is on, the switching element SW2 is off, the switching element SW3 is off, and the switching element SW4 is on. Thus, in the primary side, as indicated by solid lines in FIG. 2, a current passes across the path from the positive pole of the input voltage Vin via the switching element SW1, the primary winding N1, and the input capacitor C2 to the negative pole of the input voltage Vin. Thus the transformer Tr is excited, and the input capacitor C2 is charged. Moreover, in the primary-side, as indicated by broken lines in FIG. 2, a current passes across the path from the input capacitor C1 via the switching element SW1 and the primary winding N1 to the input capacitor C1, and the input capacitor C1 is discharged.

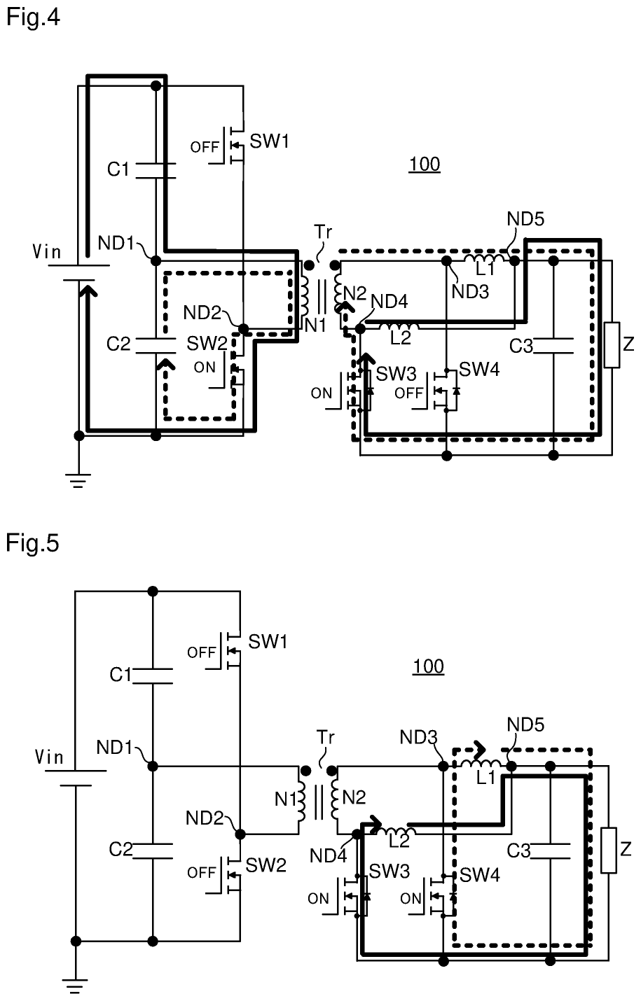

Meanwhile, in the secondary side, as indicated by solid lines in FIG. 2, a current passes across the pass from the secondary winding N2 via the inductor L2, the load Z, and the switching element SW4 to the secondary winding N2. Moreover, the inductor L1 is excited in mode C (FIG. 4), which will be described later, and thus, as indicated by broken lines in FIG. 2, a current passes across the path from the inductor L1 via the load Z and the switching element SW4 to the inductor L1.

Mode A is followed by mode B. FIG. 3 shows the operation of the switching power supply circuit 100 in mode B. As shown in FIG. 3, in mode B, the switching element SW1 is off, the switching element SW2 is off, the switching element SW3 is on, and the switching element SW4 is on. In this mode, no current passes in the primary side.

In the secondary side, the inductor L2 is excited in mode A (FIG. 2), and thus, as indicated by solid lines in FIG. 3, a current passes across the path from the inductor L2 via the load Z and the switching element SW3 to the inductor L2. Moreover, as in mode A, as indicated by broken lines in FIG. 3, a current passes across the path from the inductor L1 via the load Z and the switching element SW4 to the inductor L1.

Mode B is followed by mode C. FIG. 4 shows the operation of the switching power supply circuit 100 in mode C. As shown in FIG. 4, in mode C, the switching element SW1 is off, the switching element SW2 is on, the switching element SW3 is on, and the switching element SW4 is off. Thus, in the primary side, as indicated by solid lines in FIG. 4, a current passes across the pass from the positive pole of the input voltage Vin via the input capacitor C1, the primary winding N1, and the switching element SW2 to the negative pole of the input voltage Vin. Thus the transformer Tr is excited, and the input capacitor C1 is charged. Moreover, in the primary side, as indicated by broken lines in FIG. 4, a current passes across the path from the input capacitor C2 via the primary winding N1 and the switching element SW2 to the input capacitor C2, and the input capacitor C2 is discharged.

Meanwhile, in the secondary side, as indicated by broken lines in FIG. 4, a current passes across the path from the secondary winding N2 via the inductor L1, the load Z, and the switching element SW3 to the secondary winding N2. Moreover, as in mode B, as indicated by solid lines in FIG. 4, a current passes across the path from the inductor L2 via the load Z and the switching element SW3 to the inductor L2.

Mode C is followed by mode D. FIG. 5 shows the operation of the switching power supply circuit 100 in mode D. As shown in FIG. 5, in mode D, the switching element SW1 is off, the switching element SW2 is off, the switching element SW3 is on, and the switching element SW4 is on. In this mode, no current passes in the primary side.

In the secondary side, as in mode C (FIG. 4), as indicated by solid lines in FIG. 5, a current passes across the path from the inductor L2 via the load Z and the switching element SW3 to the inductor L2. Moreover, as indicated by broken lines in FIG. 5, the inductor L1 is excited in mode C (FIG. 4), and thus a current passes across the path from the inductor L1 via the load Z and the switching element SW4 to the inductor L1.

Mode D is followed by mode A, and thereafter modes A to D occur one after the next repeatedly.

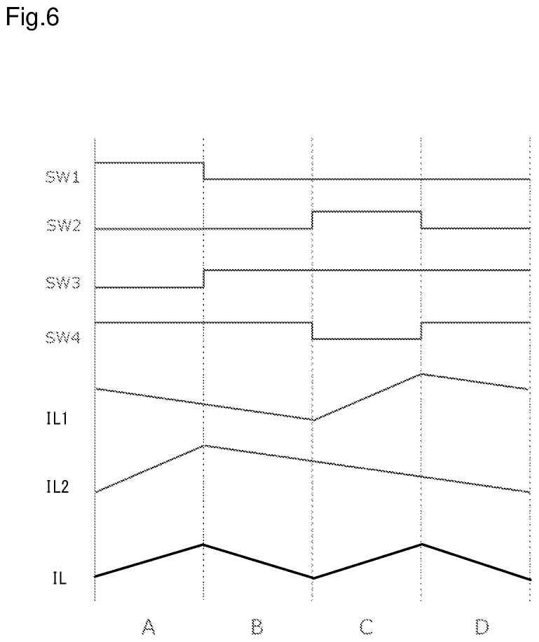

FIG. 6 is a timing chart showing one example of the operation of the switching power supply circuit 100. FIG. 6 depicts the waveforms of, from the top down, the gate signals for the switching elements SW1 to SW4, the inductor current IL1 through the inductor L1, the inductor current IL2 through the inductor L2, and the inductor output current IL, which is the composite of the inductor currents IL1 and IL2. In the gate signals for the switching elements SW1 to SW4, a high level corresponds to on, and a low level corresponds to off.

As shown in FIG. 6, the operation divides into four modes, namely modes A to D. Owing to interleaving driving in which the switching elements SW3 and SW4 are driven with phases shifted 180 degrees from each other, the inductor current IL1 so behaves as to increase in mode C by excitation and thereafter decrease in modes D, A, and B, and the inductor current IL2 so behaves as to increase in mode A by excitation and thereafter decrease in modes B, C, and D.

Adding up the inductor currents IL1 and IL2 behaving as described above helps reduce ripples in the inductor output current IL. This reduces ripples in the current Ic (FIG. 1) through the output capacitor C3, and helps reduce the size of the output capacitor C3.

In the example in FIG. 6, the on period of the switching element SW1 equals one fourth of the switching period, and the duty ratio in duty control is 25%. As will be described later, the duty ratio is controlled variably with a view to stabilizing the output voltage Vout.

### 4. Switching Power Supply Circuit of a Secondary-side Parallel Driving Configuration

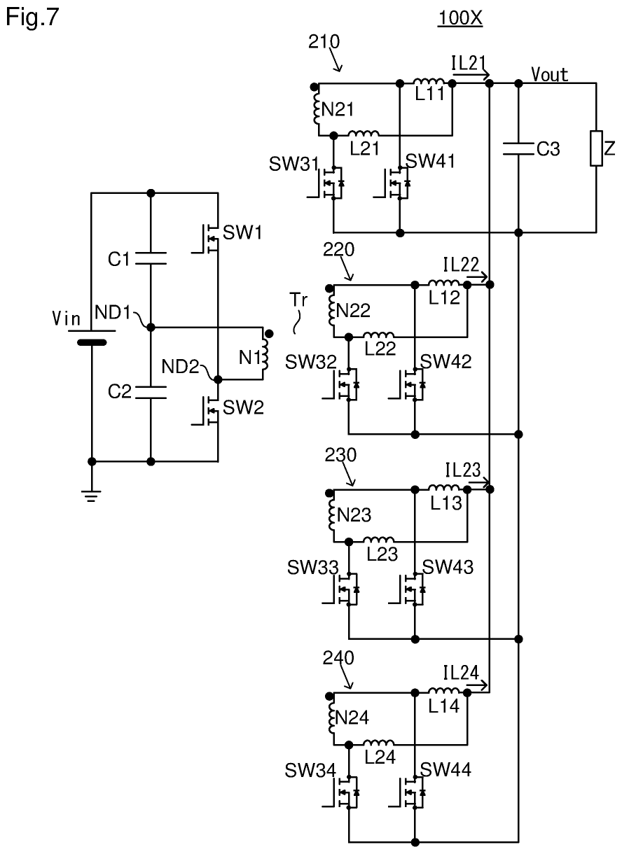

FIG. 7 is a circuit diagram of a switching power supply circuit 100X that the present inventor has devised based on the switching power supply circuit 100 described above as the study circuit.

The switching power supply circuit 100X shown in FIG. 7 has the primary side configured similarly to that of the switching power supply circuit 100 described above, but has the secondary side configured such that a plurality of circuits each corresponding to the secondary-side circuit in the switching power supply circuit 100 are connected in parallel; here, as an example, four such circuits are connected in parallel.

Specifically, the switching power supply circuit 100X has secondary-side circuits 210 to 240 connected in parallel. The secondary-side circuits 210 to 240 each have a configuration similar to that of the circuit in the switching power supply circuit 100 that includes the secondary winding N2, the inductors L1 and L2, and the switching elements SW3 and SW4. Specifically the secondary-side circuits 210 to 240 respectively include, as the secondary winding N2, secondary windings N21 to N24; as the inductor L1, inductors L11 to L14; as the inductor L2, inductors L21 to L24; as the switching element SW3, switching elements SW31 to SW34; and as the switching element SW4, switching elements SW41 to SW44.

In the switching power supply circuit 100X, the transformer Tr is composed of a primary winding N1 and secondary windings N21 to N24. The secondary windings N21 to N24 are magnetically coupled to the primary winding N1.

The secondary-side circuits 210 to 240 are, at their output side, all connected to, so as to share, the output capacitor C3. Between the terminals of the output capacitor C3, a load Z is connected.

The switching power supply circuit 100X configured as described above operates, like the switching power supply circuit 100 described above, in one of modes A to D, with the switching elements SW31 to SW34 driven synchronously in a similar manner to the switching element SW3, and the switching elements SW41 to SW44 driven synchronously in a similar manner to the switching element SW4.

In this switching power supply circuit 100X, the inductor current passes in a form divided into four inductor output currents IL21 to IL24 in the secondary-side circuits 210 to 240 respectively. This helps reduce the current that passes in each of the switching elements SW31 to SW34 and SW41 to SW44 and thereby reduce the conduction loss ascribable to the on-state resistances of those switching elements. Moreover, the secondary-side circuits 210 to 240 each have two switching elements. This helps further reduce the current that passes in each switching element and thereby further reduce the conduction loss.

### 5. Study for a Driving Scheme for Higher Efficiency

To follow is a study, by the present inventor, for a driving scheme that offers high efficiency over a wide output power range on the switching power supply circuit 100X configured as shown in FIG. 7.

If, for the sake of discussion, the driving scheme disclosed in Patent Document 1 mentioned earlier is applied to the switching power supply circuit 100X, even when the switching elements in any of the secondary-side circuits 210 to 240 are kept constantly off, a current passes through the body diodes of the switching elements, and the resulting diode loss causes a drop in efficiency. Thus a different driving scheme has to be devised.

In the switching power supply circuit 100X, a higher current has to be handled in the secondary side than in the primary side; thus it is of great significance to provide, as described above, the multiple secondary-side circuits 210 to 240 with two switching elements provided in each of them in order to reduce the current passing through each switching element and thereby reduce conduction loss. This is because conduction loss is proportional to the square of current magnitude. The downside is that the larger number of switching elements in the secondary side, specifically 2×4=8, tend to lead to greater gate driving loss resulting from the charging of the gate capacitance of the switching elements.

In the switching power supply circuit 100X, for the switching elements in the secondary side that has to handle a higher current, elements with a low on-state resistance are used to reduce conduction loss. Disadvantageously, a low on-state resistance means a larger size, and hence a higher gate capacitance. Accordingly, the secondary-side switching elements tend to cause great gate driving loss.

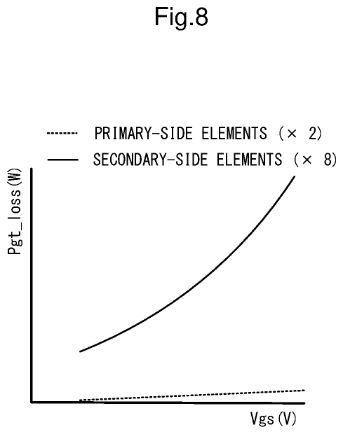

FIG. 8 is a chart showing the relationship of the gate driving voltage Vgs with the gate driving loss Pgt loss for the two primary-side switching elements (SW1, SW2) and for the eight secondary-side switching elements (SW31 to SW34, SW41 to SW44). While the primary- and secondary-side switching elements are all transistors using GaN as a semiconductor material, those in the secondary side have a higher gate capacitance. FIG. 8 shows the results observed in an example where the switching frequency is high.

The secondary side has a larger number of switching elements and these have a higher gate capacitance; thus, as will be understood from FIG. 8, the secondary-side switching elements exhibit a greater variation in gate driving loss Pgt loss as the gate driving voltage Vgs is adjusted, and have a stronger effect on efficiency.

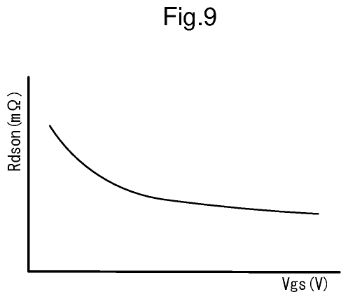

FIG. 9 is a chart showing the relationship of the gate driving voltage Vgs with the on-state resistance Rdson with respect to the secondary-side switching elements in the switching power supply circuit 100X. It should be noted that FIG. 9 shows a relationship at a predetermined drain current. As shown in FIG. 9, as the gate driving voltage Vgs is reduced, the on-state resistance increases. On the other hand, as shown in FIG. 8, as the gate driving voltage Vgs is reduced, the gate driving loss reduces. Thus, there is a trade-off between the on-state resistance and the gate driving loss.

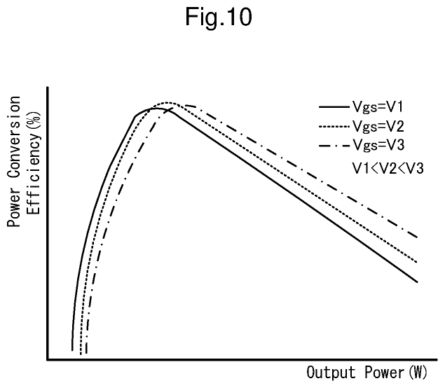

FIG. 10 is a chart showing the relationship of the output power with efficiency as observed as the gate driving voltage Vgs for the secondary-side switching elements is varied among predetermined voltages V1, V2, and V3 (V1<V2<V3) in the switching power supply circuit 100X.

As shown in FIG. 10, at a low output power, the gate driving loss is dominant over the conduction loss ascribable to the on-state resistance, and thus reducing the gate driving voltage Vgs leads to higher efficiency; at a high output power, the conduction loss is dominant over the gate driving loss, and thus increasing the gate driving voltage Vgs and reducing the on-state resistance leads to higher efficiency. This confirms that, for a given output power, there exists a given optimal gate driving voltage Vgs.

It has thus been found out that a scheme that is effective on the switching power supply circuit 100X is one that variably controls the gate driving voltage Vgs for driving the secondary-side switching elements in accordance with the output power. Specifically, the control can be performed such that, as the output power reduces, the gate driving voltage Vgs is reduced

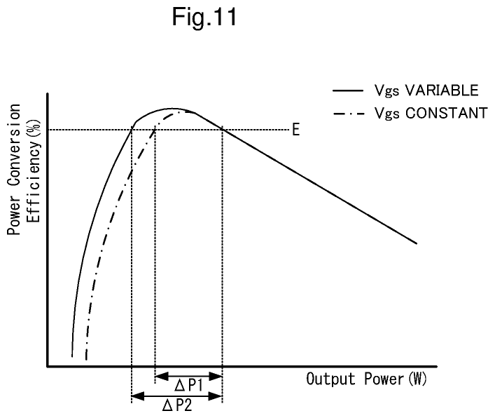

FIG. 11 is a chart showing the relationship of the output power with efficiency as observed when the gate driving voltage Vgs for the secondary-side switching elements is variably controlled and when it is kept constant at the voltage V3 mentioned above. As shown in FIG. 11, the range of output power in which predetermined efficiency (e.g., 90%) or higher is obtained is, with Vgs variable, ΔP2, and, with Vgs constant, ΔP1, where ΔP2>ΔP1. It is thus understood that variably controlling the gate driving voltage Vgs leads to high efficiency in a wider range of output power. It is also understood from FIG. 11 that variably controlling the gate driving voltage Vgs leads to higher maximum efficiency.

### 6. First Embodiment

Based on the above-described study on a driving scheme, the present inventor has devised switching power supply circuits according to some embodiments as will be described below. First, a switching power supply circuit according to a first embodiment will be described.

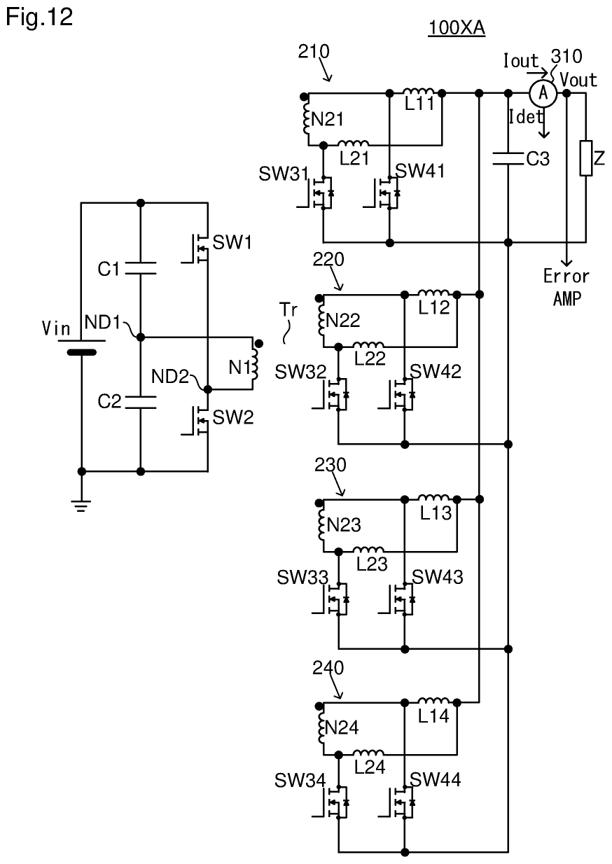

FIG. 12 is a circuit diagram showing the configuration of a switching power supply circuit 100XA according to a first embodiment. The switching power supply circuit 100XA shown in FIG. 12, as compared with the switching power supply circuit 100X (FIG. 7) described above, further includes a current detector 310. In FIG. 12, the output voltage Vout is fed to an error amplifier (not illustrated) for feedback control. The configuration, including the error amplifier, for feedback control will be described later.

The current detector 310 is, for example, a current sensor employing a Hall-effect sensor, and outputs, as a voltage signal reflecting the detected current, a current detection signal Idet. The current detector 310 is disposed in the stage succeeding the output capacitor C3. Thus the current detector 310 detects an output current lout that passes from the switching power supply circuit 100XA to the load Z.

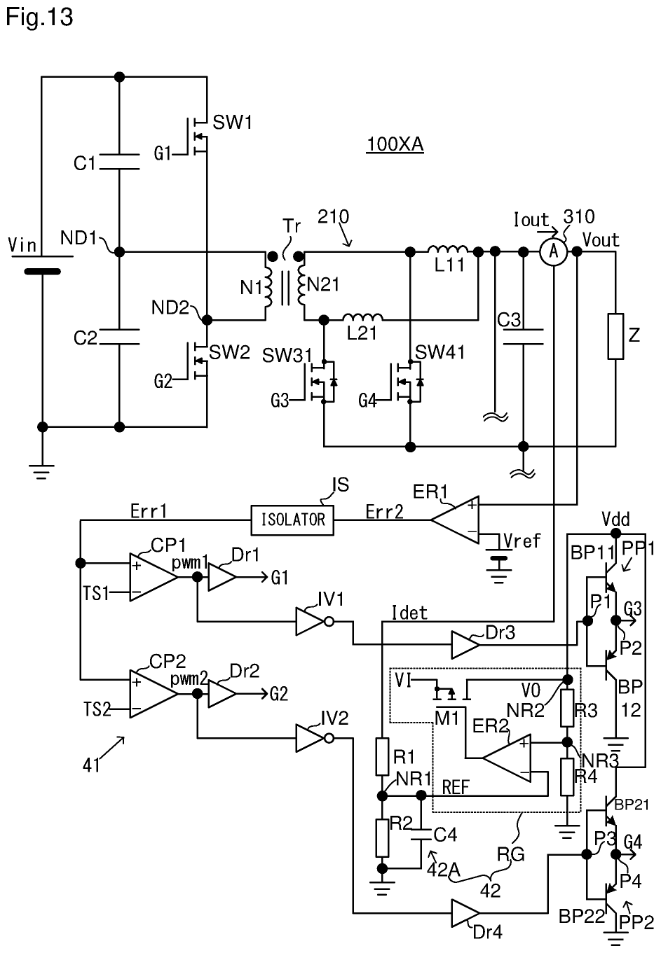

FIG. 13 is a circuit diagram showing the configuration related to gate driving voltage variable control for the secondary-side switching elements and feedback control for the output voltage Vout in the switching power supply circuit 100XA shown in FIG. 12. For convenience' sake, in FIG. 13, the secondary-side circuits 220 to 240 are omitted from illustration.

The switching power supply circuit 100XA includes a feedback controller 41 that performs feedback control for the output voltage Vout. The feedback controller 41 includes an error amplifier ER1, an isolator IS, comparators CP1 and CP2, drivers Dr1 to Dr4, inverters IV1 and IV2, and push-pull circuits PP1 and PP2.

Of the error amplifier ER1, one input terminal is fed with the output voltage Vout, and the other input terminal is fed with a reference voltage Vref. The error amplifier ER1 amplifies the error of the output voltage Vout from the reference voltage Vref, and outputs the result as an error signal Err2. The error signal Err2 is fed, as an error signal Err1, via the isolator IS, which includes a photocoupler or the like, to one input terminal of the comparator CP1 and to one input terminal of the comparator CP2.

The other input terminal of the comparator CP1 is fed with a triangular-wave signal TS1. The comparator CP1 compares the error signal Err1 with the triangular-wave signal TS1, and outputs a PWM signal pwm1 as the result of the comparison. Based on the PWM signal pwm1, the driver Dr1 outputs a gate driving signal G1 for driving the gate of the switching element SW1. The PWM signal pwm1 has its level inverted by the inverter IV1, and the result is fed via the driver Dr3 to the push-pull circuit PP1. The inverter IV1 includes a photocoupler or the like for isolation.

The push-pull circuit PP1 includes an NPN transistor BP11 and a PNP transistor BP12. The collector of the NPN transistor BP11 is fed with a supply voltage Vdd. To the connection node P1 to which the base of the NPN transistor BP11 and the base of the PNP transistor BP12 are connected, the output terminal of the driver Dr3 is connected. The collector of the PNP transistor BP12 is fed with the ground potential. From the connection node P2 to which the emitter of the NPN transistor BP11 and the emitter of the PNP transistor BP12 are connected, a gate driving voltage G3 for driving the gate of the switching element SW31 is output.

When the output of the driver Dr3 is high, the NPN transistor BP11 is on and the PNP transistor BP12 is off; thus the gate driving voltage G3 is high, being equal to the supply voltage Vdd. By contrast, when the output of the driver Dr3 is low, the NPN transistor BP11 is off and the PNP transistor BP12 is on; thus the gate driving voltage G3 is low, being equal to the ground potential. The supply voltage Vdd is variable under the control of a variable controller 42, which will be described later.

The other input terminal of the comparator CP2 is fed with a triangular-wave signal TS2. The triangular-wave signal TS2 has a phase shifted by 180 degrees relative to the triangular-wave signal TS1. The comparator CP2 compares the error signal Err1 with the triangular-wave signal TS2, and outputs a PWM signal pwm2 as the result of the comparison. Based on the PWM signal pwm2, the driver Dr2 outputs a gate driving signal G2 for driving the gate of the switching element SW2. The PWM signal pwm2 has its level inverted by the inverter IV2, and the result is fed via the driver Dr4 to the push-pull circuit PP2. The inverter IV2 includes a photocoupler or the like for isolation

The push-pull circuit PP2 includes an NPN transistor BP21 and a PNP transistor BP22. The collector of the NPN transistor BP21 is fed with the supply voltage Vdd. To the connection node P3 to which the base of the NPN transistor BP21 and the base of the PNP transistor BP22 are connected, the output terminal of the driver Dr4 is connected. The collector of the PNP transistor BP22 is fed with the ground potential. From the connection node P4 to which the emitter of the NPN transistor BP21 and the emitter of the PNP transistor BP22 are connected, a gate driving voltage G4 for driving the gate of the switching element SW41 is output.

When the output of the driver Dr4 is high, the NPN transistor BP21 is on and the PNP transistor BP22 is off; thus the gate driving voltage G4 is high, being equal to the supply voltage Vdd. By contrast, when the output of the driver Dr4 is low, the NPN transistor BP21 is off and the PNP transistor BP22 is on; thus the gate driving voltage G4 is low, being equal to the ground potential.

Owing to the feedback controller 41 configured as described above, the duty ratios of the PWM signals pwm1 and pwm2 are adjusted in accordance with the output voltage Vout, and the primary-side switching elements SW1 and SW2 are subjected to switching control by the gate driving signals G1 and G2. In this way, it is possible to stabilize the output voltage Vout through simple duty control. Here, the period of the triangular-wave signals TS1 and TS2 is equal to the period of the PWM signals pwm1 and pwm2, that is, the switching period, and the PWM signals pwm1 and pwm2 have phases 180 degrees shifted from each other.

Moreover, owing to the inverters IV1 and IV2 inverting the levels of the PWM signals pwm1 and pwm2, the gate driving signals G3 and G4 have inverted levels compared with the gate driving signals G1 and G2.

In this way, switching control as described above and shown in the timing chart in FIG. 6 (with SW3 and SW4 corresponding to SW31 and SW41) is achieved.

Moreover, as shown in FIG. 13, the switching power supply circuit 100XA includes a variable controller 42 that performs variable control for the supply voltage Vdd based on the result of detection of the output current Iout. The variable controller 42 includes a reference voltage generator 42A and a regulator RG.

The reference voltage generator 42A includes resistors R1 and R2 and a capacitor C4. The resistors R1 and R2 are connected in series between an output terminal for the current detection signal Idet from the current detector 310 and the application terminal for the ground potential. Between the connection node NR1 to which the resistors R1 and R2 are connected and the application terminal for the ground potential, the capacitor C4 is connected. Thus the current detection signal Idet, which is a voltage signal, is voltage-divided by the resistors R1 and R2 and smoothed by the capacitor C4 to become a reference voltage REF. Thus the reference voltage generator 42A generates the reference voltage REF based on the current detection signal. The capacitor C4 may be omitted.

The regulator RG includes an error amplifier ER2, an output transistor M1, and resistors R3 and R4. The one input terminal of the error amplifier ER2 is fed with the reference voltage REF. The output terminal of the error amplifier ER2 is connected to the gate of the output transistor M1, which is configured as a p-channel MOSFET. The source of the output transistor M1 is fed with a predetermined input voltage VI. The drain of the output transistor M1 is connected, at a connection node NR2, to the first terminal of the resistor R3. The second terminal of the resistor R3 is connected, at a connection node NR3, to the first terminal of the resistor R4. The connection node NR3 is connected to the other input terminal of the error amplifier ER2. The second terminal of the resistor R4 is connected to the application terminal for the ground potential.

Owing to the regulator RG being configured as described above, the voltage at the connection node NR3 is controlled so as to remain equal to the reference voltage REF, and an output voltage VO commensurate with the voltage at the connection node NR3 appears at the connection node NR2. The connection node NR2 is connected to the collector of the NPN transistor BP11 in the push-pull circuit PP1 and to the collector of the NPN transistor BP21 in the push-pull circuit PP2, and thus the output voltage VO is applied, as the supply voltage Vdd, to the collectors of the NPN transistors BP11 and BP21.

With this configuration, the reference voltage REF is generated in accordance with the current detection signal Idet, which is the result of detecting with the current detector 310 the output current Tout as a physical quantity related to the output power, and the regulator RG generates the output voltage VO commensurate with the reference voltage REF, that is, the supply voltage Vdd, and this is applied to the push-pull circuits PP1 and PP2. The supply voltage Vdd serves, when the NPN transistors BP11 and BP21 are on, as the gate driving voltages G3 and G4 to keep the switching elements SW31 and SW41 on.

Specifically, as the output current Tout increases, the reference voltage REF is higher and hence the supply voltage Vdd is higher; thus the gate driving voltages G3 and G4 for keeping the switching elements SW31 and SW41 on are higher. This achieves control for varying the gate driving voltage for the secondary-side switching elements in accordance with the output power.

In particular, this embodiment provides the benefit of reducing the number of current detectors 310. As for the driving of the switching elements in the secondary-side circuits 220 to 240 other than the secondary-side circuit 210 in the switching power supply circuit 100XA, for example, circuits similar to the push-pull circuits PP1 and PP2, to which the output terminals of the drivers Dr3 and Dr4 and an application terminal for the supply voltage Vdd are connected, can be provided in each of the secondary-side circuits 220 to 240. This achieves synchronous switching control of the switching elements SW31 to SW34 and synchronous switching control of the switching elements SW41 to SW44.

While the configuration of the feedback controller 41 shown in FIG. 13 does not give consideration to a dead time, a configuration is also possible that gives consideration to a dead time as necessary.

### 7. Second Embodiment

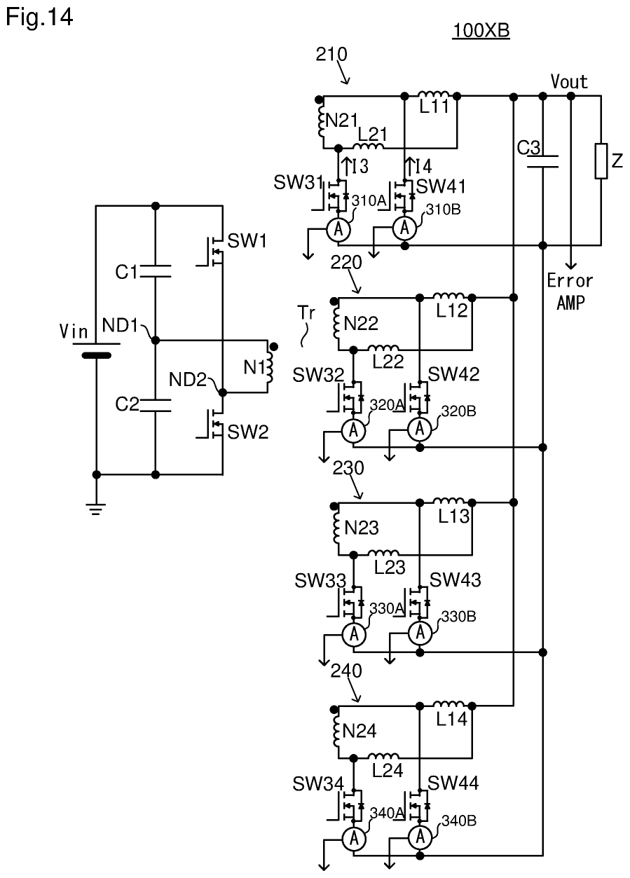

Next, a second embodiment will be described. The following description focuses on differences from the first embodiment. FIG. 14 is a circuit diagram showing the configuration of a switching power supply circuit 100XB according to the second embodiment.

As will be seen from FIG. 14, the switching power supply circuit 100XB differs from that of the first embodiment (FIG. 12) in where to arrange current detectors. Specifically, in the switching power supply circuit 100XB, the secondary-side circuit 210 includes current detectors 310A and 310B to detect the currents through the switching elements SW31 and SW41 respectively; the secondary-side circuit 220 includes current detectors 320A and 320B to detect the currents through the switching elements SW32 and SW42 respectively; the secondary-side circuit 230 includes current detectors 330A and 330B to detect the currents through the switching elements SW33 and SW43 respectively; and the secondary-side circuit 240 includes current detectors 340A and 340B to detect the currents through the switching elements SW34 and SW44 respectively.

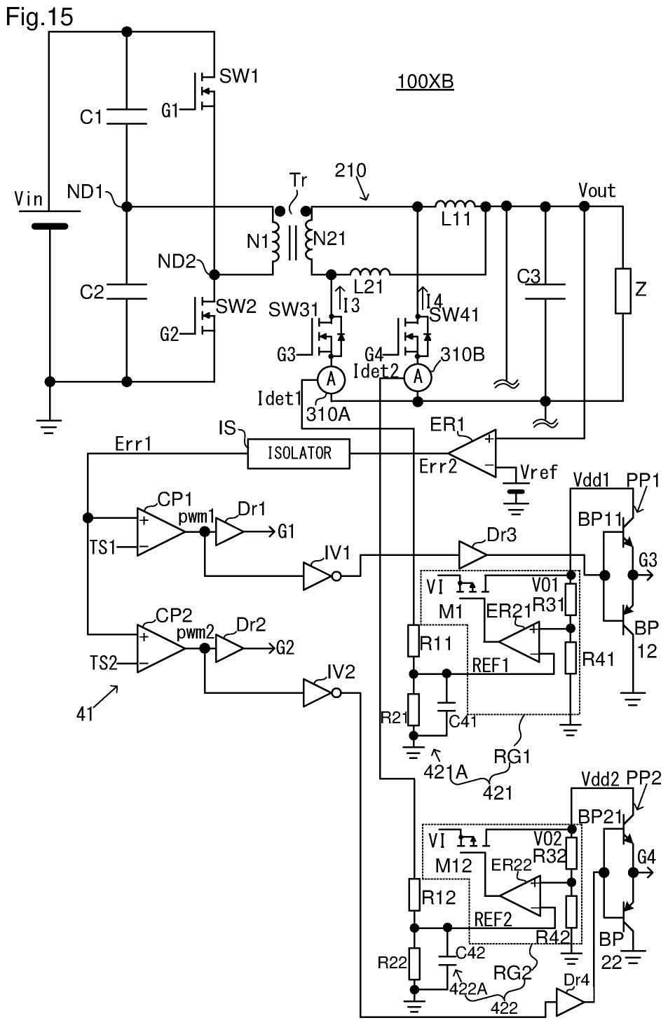

FIG. 15 is a circuit diagram showing the configuration related to gate driving voltage variable control for the secondary-side switching elements and feedback control for the output voltage Vout in the switching power supply circuit 100XB shown in FIG. 14. For convenience' sake, in FIG. 15, the secondary-side circuits 220 to 240 are omitted from illustration.

As shown in FIG. 15, the switching power supply circuit 100XB includes a feedback controller 41. The feedback controller 41 is configured similarly as in the first embodiment (FIG. 13), and accordingly will not be discussed in detail.

As shown in FIG. 15, the switching power supply circuit 100XB also includes variable controllers 421 and 422. The variable controller 421 includes a reference voltage generator 421A and a regulator RG1. The reference voltage generator 421A includes resistors R11 and R21 and a capacitor C41.

The first terminal of the resistor R11 is fed with a current detection signal Idet1 output from the current detector 310A. The reference voltage generator 421A is configured similarly to the reference voltage generator 42A in the first embodiment (FIG. 13). The regulator RG1 is configured similarly to the regulator RG in the first embodiment. Accordingly, in accordance with the current detection signal Idet1 the reference voltage generator 421A generates a reference voltage REF1, and in accordance with the reference voltage REF1 the regulator RG1 generates an output voltage VO1 and applies it as a supply voltage Vdd1 to the collector of the NPN transistor BP11 in the push-pull circuit PP 1.

The variable controller 422 includes a reference voltage generator 422A and a regulator RG2. The reference voltage generator 422A includes resistors R12 and R22 and a capacitor C42.

The first terminal of the resistor R12 is fed with a current detection signal Idet2 output from the current detector 310B. The reference voltage generator 422A is configured similarly to the reference voltage generator 42A in the first embodiment (FIG. 13). The regulator RG2 is configured similarly to the regulator RG in the first embodiment. Accordingly, in accordance with the current detection signal Idet2 the reference voltage generator 422A generates a reference voltage REF2, and in accordance with the reference voltage REF2 the regulator RG2 generates an output voltage VO2 and applies it as a supply voltage Vdd2 to the collector of the NPN transistor BP21 in the push-pull circuit PP2.

With this configuration, the supply voltages Vdd1 and Vdd2 are generated in accordance with the current detection signals Idet1 and Idet2, which are the results of detecting with the current detectors 310A and 310B the currents 13 and 14 through the switching elements SW31 and S41 respectively as physical quantities related to the output power, and are applied to the push-pull circuits PP1 and PP2. The supply voltages Vdd1 and Vdd2 serve, when the NPN transistors BP11 and BP21 are on, as the gate driving voltages G3 and G4 to keep the switching elements SW31 and SW41 on.

Specifically, as the currents 13 and 14 increase, the reference voltages REF1 and REF2 is higher and hence the supply voltages Vdd1 and Vdd2 are higher; thus the gate driving voltages G3 and G4 for keeping the switching elements SW31 and SW41 on are higher. This achieves control for varying the gate driving voltage for the secondary-side switching elements in accordance with the output power.

As for the driving of the switching elements in the secondary-side circuits 220 to 240, circuits similar to the variable controllers 421 and 422 can be provided for the current detectors in each of the secondary-side circuits 220 to 240, and circuits similar to the push-pull circuits PP1 and PP2, to which the output terminals of the drivers Dr3 and Dr4 and application terminals for the supply voltages Vdd1 and Vdd2 are connected, can be provided in each of the secondary-side circuits 220 to 240.

With this embodiment, even if there are variations among the secondary-side circuits 210 to 240 in terms of inductor characteristics and conductor impedance, owing to the variable control of the gate driving voltages for the individual switching elements achieved through detection of the currents through those switching elements respectively om the secondary-side circuits 210 to 240, it is possible to effectively improve efficiency.

### 8. Third Embodiment

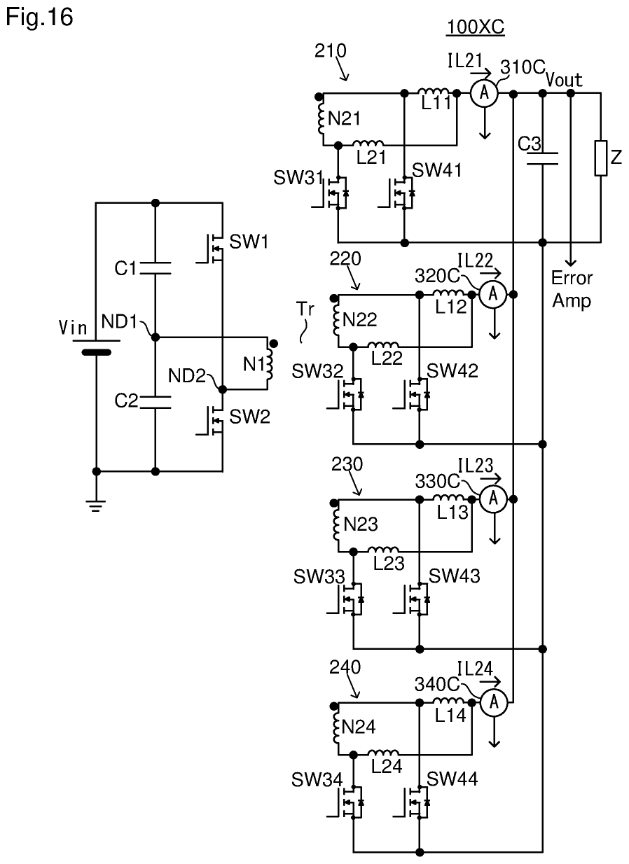

Next, a third embodiment will be described. The following description focuses on differences from the first embodiment. FIG. 16 is a circuit diagram showing the configuration of a switching power supply circuit 100XC according to the third embodiment.

As will be seen from FIG. 16, the switching power supply circuit 100XC differs from that the first embodiment (FIG. 12) in where to arrange current detectors. Specifically, in the switching power supply circuit 100XC, the secondary-side circuit 210 includes a current detector 310C to detect an inductor output current IL21 generated by adding up the currents passing through the inductors L11 and L12 respectively; the secondary-side circuit 220 includes a current detector 320C to detect an inductor output current IL22 generated by adding up the currents passing through the inductors L12 and L22; the secondary-side circuit 230 includes a current detector 330C to detect an inductor output current IL23 generated by adding up the currents passing through the inductors L13 and L23 respectively; and the secondary-side circuit 240 includes a current detector 340C to detect an inductor output current IL24 generated by adding up the currents passing through the inductors L14 and L24 respectively.

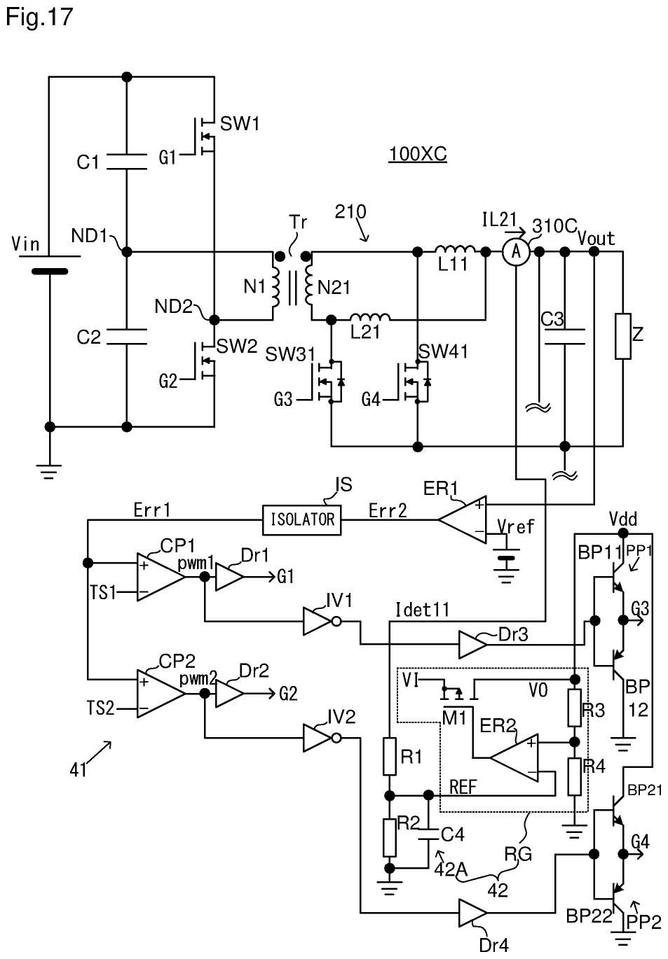

FIG. 17 is a circuit diagram showing the configuration related to gate driving voltage variable control for the secondary-side switching elements and feedback control for the output voltage Vout in the switching power supply circuit 100XC shown in FIG. 17. For convenience' sake, in FIG. 17, the secondary-side circuits 220 to 240 are omitted from illustration.

As shown in FIG. 17, the switching power supply circuit 100XC includes a feedback controller 41. The feedback controller 41 is configured similarly as in the first embodiment (FIG. 13), and accordingly will not be discussed in detail.

As shown in FIG. 17, the switching power supply circuit 100XC also includes a variable controller 42. The variable controller 42 is configured similarly as in the first embodiment (FIG. 13), and accordingly will not be discussed in detail. A current detection signal Idet11, which is the result of detecting the inductor output current IL21 with the current detector 310C, is fed to the first terminal of the resistor R1. Thus, in accordance with the current detection signal Idet11 the reference voltage generator 42A generates a reference voltage REF, and in accordance with the reference voltage REF the regulator RG generates an output voltage VO and applies it as a supply voltage Vdd to the collectors of the NPN transistors BP11 and BP21 in the push-pull circuits PP1 and PP2.

With this configuration, the supply voltage Vdd is generated in accordance with the current detection signal Idet11, which is the result of detecting with the current detector 310C the inductor output current IL21 as a physical quantity related to the output power, and is applied to the push-pull circuits PP1 and PP2. The supply voltage Vdd serves, when the NPN transistors BP11 and BP21 are on, as the gate driving voltages G3 and G4 to keep the switching elements SW31 and SW41 on.

Specifically, as the inductor output current IL21 increases, the reference voltage REF is higher and hence the supply voltage Vdd is higher; thus the gate driving voltages G3 and G4 for keeping the switching elements SW31 and SW41 on are higher. This achieves control for varying the gate driving voltage for the secondary-side switching elements in accordance with the output power.

As for the driving of the switching elements in the secondary-side circuits 220 to 240, circuits similar to the variable controller 42 can be provided for the current detectors 320C, 330C, and 340C in each of the secondary-side circuits 220 to 240, and circuits similar to the push-pull circuits PP1 and PP2, to which the output terminals of the drivers Dr3 and Dr4 and the application terminal for the supply voltage Vdd is connected, can be provided in each of the secondary-side circuits 220 to 240.

With this embodiment, in a case where, although there are variations among the currents passing through the secondary-side circuits 210 to 240 respectively, substantially equal currents pass through the individual switching elements in the same secondary-side circuit, it is possible, by adjusting the gate driving voltage for the switching elements in each secondary-side circuit, to effectively improve efficiency. With this embodiment, it is also possible to reduce the number of current detectors as compared with the second embodiment.

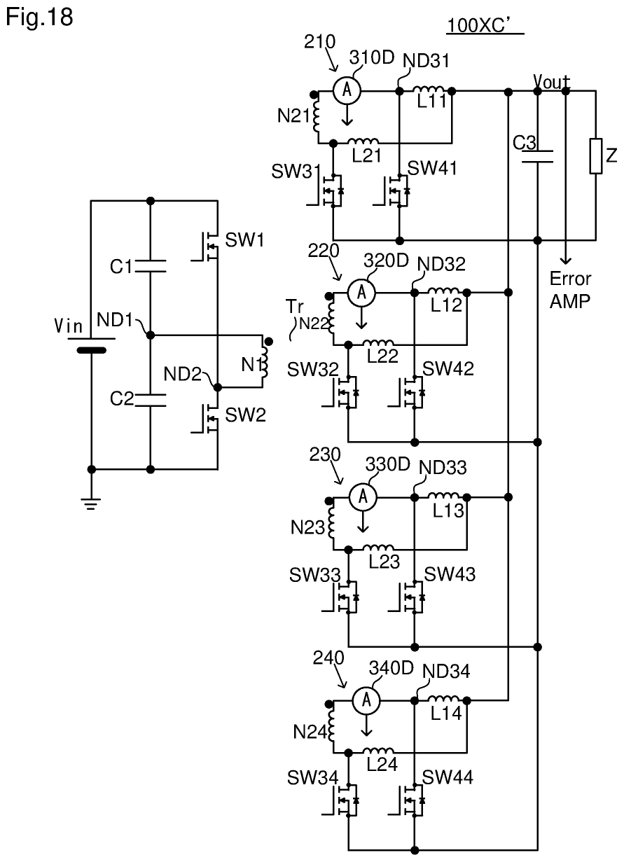

FIG. 18 is a circuit diagram showing the configuration of a switching power supply circuit 100XC′ as one modified example of the third embodiment. The switching power supply circuit 100XC′ differs from the switching power supply circuit 100XC described above in where to arrange current detectors. Specifically, the secondary-side circuit 210 includes a current detector 310D arranged between the first terminal of the secondary winding N21 and the connection node ND31 to which the drain of the switching element SW41 and the first terminal of the inductor L11 are connected; the secondary-side circuit 220 includes a current detector 320D arranged between the first terminal of the secondary winding N22 and the connection node ND32 to which the drain of the switching element SW42 and the first terminal of the inductor L12 are connected; the secondary-side circuit 230 includes a current detector 330D arranged between the first terminal of the secondary winding N23 and the connection node ND33 to which the drain of the switching element SW43 and the first terminal of the inductor L13 are connected; and the secondary-side circuit 240 includes a current detector 340D arranged between the first terminal of the secondary winding N24 and the connection node ND34 to which the drain of the switching element SW44 and the first terminal of the inductor L14 are connected.

Also with this configuration, as with that of the third embodiment, it is possible to adjust the gate driving voltages for the switching elements in each secondary-side circuit. As will be understood from the operation in modes A to D described earlier, there is a period in which no current passes through the current detectors 310D to 340D, and this requires that the capacitor C4 for smoothing in the variable controller 42 have a high capacity. In this regard, the third embodiment is preferable because, there, currents constantly pass through the current detectors and a lower capacitance suffices in the capacitor C4.

### 9. Fourth Embodiment

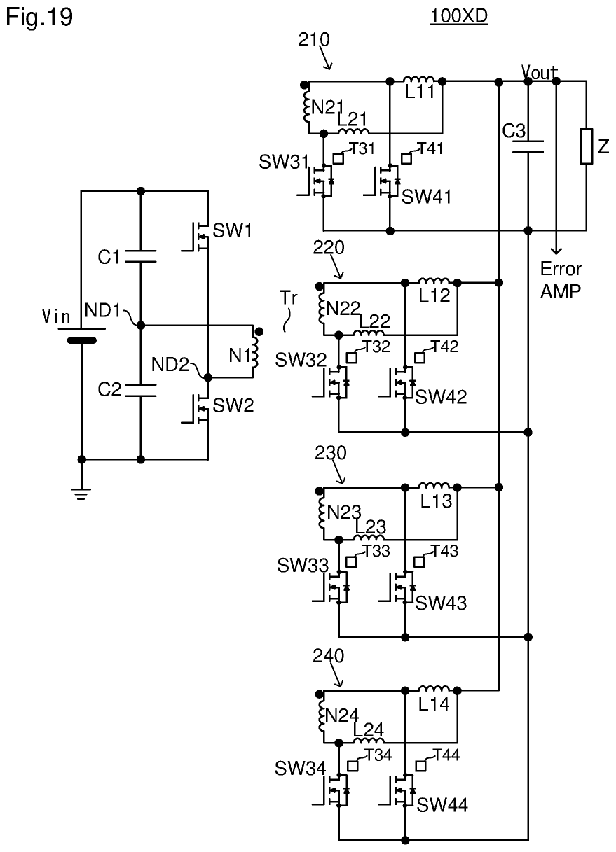

Next, a fourth embodiment will be described. FIG. 19 is a circuit diagram showing the configuration of a switching power supply circuit 100XD according to the fourth embodiment.

As shown in FIG. 19, the switching power supply circuit 100XD includes temperature detectors T31 to T34 that detect the temperatures of the switching elements SW31 to SW34 respectively, and temperature detectors T41 to T44 that detect the temperatures of the switching elements SW41 to SW44 respectively.

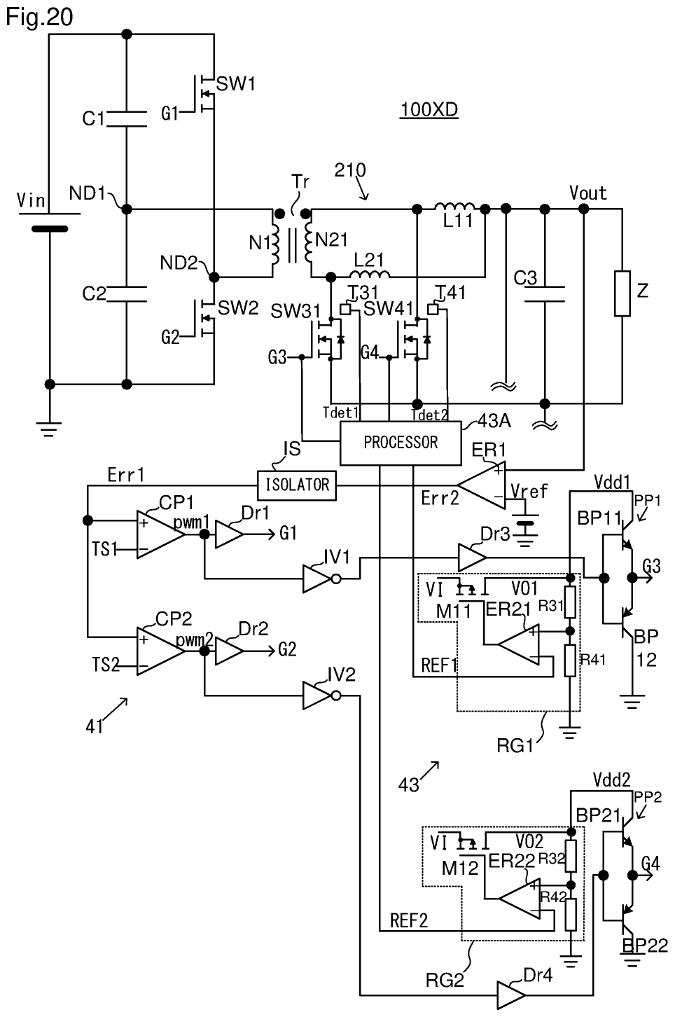

FIG. 20 is a circuit diagram showing the configuration related to gate driving voltage variable control for the secondary-side switching elements and feedback control for the output voltage Vout in the switching power supply circuit 100XD shown in FIG. 19. For convenience' sake, in FIG. 20, the secondary-side circuits 220 to 240 are omitted from illustration.

As shown in FIG. 20, the switching power supply circuit 100XD includes a feedback controller 41. The feedback controller 41 is configured similarly as in the first embodiment (FIG. 13), and accordingly will not be discussed in detail.

As shown in FIG. 20, the switching power supply circuit 100XD also includes a variable controller 43. The variable controller 43 includes a processor 43A and regulators RG1 and RG2. The regulators RG1 and RG2 are configured similarly as in the second embodiment (FIG. 15).

The processor 43A acquires a temperature detection signal Tdet1, which is the result of detecting the temperature of the switching element SW31 with the temperature detector T31, and a temperature detection signal Tdet2, which is the result of detecting the temperature of the switching element SW41 with the temperature detector T41. The processor 43A also acquires the gate driving voltage G3 with which the switching element SW31 is driven and the gate driving voltage G4 with which the switching element SW41 is driven.

Here, the temperature T of a switching element and the loss Ploss in the switching element have the relationship

T=Rth×Ploss (1)

where Rth is the thermal resistance. Since Rth is known, detecting the temperature T of the switching element permits one to calculate Ploss.

Considering that the switching loss in the secondary side is almost zero, the loss Ploss is given by the following expression:

Ploss=Pgate+Pcond (2)

where Pgate is the gate driving loss and Pcond is the conduction loss.

Here, the gate driving loss Pgate is given by the following expression:

Pgate=C×Vgs²×f² (3)

where C is the gate capacitance of the switching element, Vgs is the gate driving voltage, and f is the switching frequency.

Since the gate capacitance C and the switching frequency f are known, acquiring the gate driving voltage Vgs permits one to calculate the gate driving loss Pgate by expression (3).

Once Ploss and Pgate are calculated, one can calculate the conduction loss Pcond by expression (2).

Through those calculations, the processor 43A calculates the conduction loss Pcond in the switching element SW31 from the temperature detection signal Tdet1 and the gate driving voltage G3, and calculates the conduction loss Pcond in the switching element SW41 from the temperature detection signal Tdet2 and the gate driving voltage G4.

Then, in accordance with the proportion of the conduction loss Pcond in the switching element SW31 out of the loss Ploss there, the processor 43A feeds the reference voltage REF1 to the regulator RG1, and in accordance with the proportion of the conduction loss Pcond in the switching element SW41 out of the loss Ploss there, the processor 43A feeds the reference voltage REF2 to the regulator RG2.

The regulator RG1 applies, as the supply voltage Vdd1, the output voltage VO1 commensurate with the reference voltage REF1 to the push-pull circuit PP1, and the regulator RG2 applies, as the supply voltage Vdd2, the output voltage VO2 commensurate with the reference voltage REF2 to the push-pull circuit PP2. Accordingly, the higher the proportion of the conduction loss Pcond in the switching element SW31 out of the loss Ploss there, the supply voltage Vdd1 is raised and the gate driving voltage G3 for keeping the switching element SW31 on is higher. Likewise, the higher the proportion of the conduction loss Pcond in the switching element SW41 out of the loss Ploss there, the supply voltage Vdd2 is raised and the gate driving voltage G4 for keeping the switching element SW41 on is higher.

That is, detecting the temperature of a switching element as a physical quantity related to the output power permits variable control of the gate driving voltage. As a result, whereas a configuration employing a current detector suffers from loss in particular in applications with a high current in the secondary side, this embodiment does not require a current detector.

The processor 43A may instead calculate the current passing through a switching element from the calculated conduction loss Pcond and the known on-state resistance and generate a reference voltage in accordance with the calculated current.

As for the driving of the switching elements in the secondary-side circuits 220 to 240, circuits configured similarly to the variable controller 43 and the push-pull circuits PP1 and PP2 described above can be provided for each of the secondary-side circuits 220 to 240.

### 10. Circuit Layout

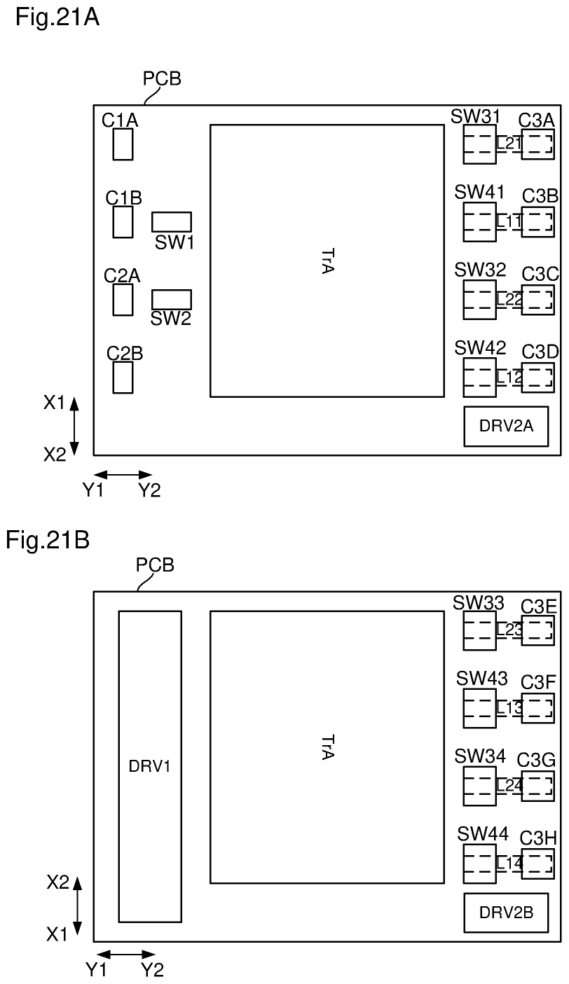

Now, in connection with the switching power supply circuits according to the different embodiments described above, their layout will be described. FIG. 21A is a schematic plan view of one example of the layout of a switching power supply circuit on a printed circuit board PCB as seen from its obverse side. FIG. 21B is a schematic plan view of one example of the layout of a switching power supply circuit on a printed circuit board PCB as seen from its reverse side.

In FIGS. 21A and 21B, the direction along the vertical sides of the printed circuit board PCB in a rectangular shape is taken as X direction, along which one side is indicated as X1 and the other side as X2; the direction along the horizontal sides of the printed circuit board PCB is taken as Y direction, along which one side is indicated as Y1 and the other side as Y2. Of the printed circuit board PCB, the vertical sides are, for example, 30 mm long and the horizontal sides are, for example, 40 mm long.

As shown in FIG. 21A, as seen from the obverse side of the printed circuit board PCB, in an end part of the printed circuit board PCB at one side along Y direction, capacitors C1A, C1B, C2A, and C2B are arranged in this order toward the other side along X direction. The capacitors C1A and C1B are connected in parallel to form the input capacitor C1, and the capacitors C2A and C2B are connected in parallel to form the input capacitor C2.

The switching element SW1 is arranged adjacent to the capacitor C1B at its other side along Y direction. The switching element SW2 is arranged adjacent to the capacitor C2A at its other side along Y direction.

In an end part of the printed circuit board PCB at the other side along Y direction, capacitors C3A, C3B, C3C, and C3D are arranged in this order toward the other side along X direction. The switching element SW31 is arranged at one side of the capacitor C3A along Y direction, opposite the capacitor C3A along Y direction. The switching element SW41 is arranged at one side of the capacitor C3B along Y axis, opposite the capacitor C3B along Y direction. The switching element SW32 is arranged at one side of the capacitor C3C along Y direction, opposite the capacitor C3C along Y direction. The switching element SW42 is arranged at one side of the capacitor C3D along Y direction, opposite the capacitor C3D along Y direction.

Between the switching elements SW1 and SW2 at one side and the switching elements SW31, SW41, SW32, and SW42 at the other side along Y direction, an arrangement region TrA for the transformer Tr is formed. The transformer Tr is formed with a conductor pattern as will be described later.

At the far side of the obverse face of the printed circuit board PCB in its thickness direction (at the far side of the plane of FIG. 21A), so as to span from the switching element SW31 to the capacitor C3A, an inductor L21 formed with a conductor pattern is arranged. At the far side of the obverse face of the printed circuit board PCB in its thickness direction, so as to span from the switching element SW41 to the capacitor C3B, an inductor L11 formed with a conductor pattern is arranged. At the far side of the obverse face of the printed circuit board PCB in its thickness direction, so as to span from the switching element SW32 to the capacitor C3C, an inductor L22 formed with a conductor pattern is arranged. At the far side of the obverse face of the printed circuit board PCB in its thickness direction, so as to span from the switching element SW42 to the capacitor C3D, an inductor L12 formed with a conductor pattern is arranged.

At the other side of the switching element SW42 and the capacitor C3D along X direction, opposite the switching element SW42 and the capacitor C3D along X direction, a secondary-side driver DRV2A is formed. The secondary-side driver DRV2A drives the switching elements SW31, SW41, SW32, and SW42.

On the other hand, as shown in FIG. 21B, as seen from the reverse side of the printed circuit board PCB, in a part of the printed circuit board PCB at one side along Y direction, a primary-side driver DRV1 extending along X direction is arranged. The primary-side driver DRV1 drives the switching elements SW1 and SW2.

In an end part of the printed circuit board PCB at the other side along Y direction, capacitors C3E, C3F, C3G, and C3H are arranged in this order toward one side along X direction. The capacitors C3A to C3H are connected in parallel to form the output capacitor C3. The switching element SW33 is arranged at one side of the capacitor C3E along Y direction, opposite the capacitor C3E along Y direction. The switching element SW43 is arranged at one side of the capacitor C3F along Y direction, opposite the capacitor C3F along Y direction. The switching element SW34 is arranged at one side of the capacitor C3G along Y direction, opposite the capacitor C3G along Y direction. The switching element SW44 is arranged at one side of the capacitor C3H along Y direction, opposite the capacitor C3H along Y direction.

Between the primary-side driver DRV1 at one end and the switching elements SW33, SW43, SW34, and SW44 at the other end along Y direction, the arrangement region TrA for the transformer Tr is formed.

At the far side of the reverse face of the printed circuit board PCB in its thickness direction (at the far side of the plane of FIG. 21B), so as to span from the switching element SW33 to the capacitor C3E, an inductor L23 formed with a conductor pattern is arranged. At the far side of the reverse face of the printed circuit board PCB in its thickness direction, so as to span from the switching element SW43 to the capacitor C3F, an inductor L13 formed with a conductor pattern is arranged. At the far side of the reverse face of the printed circuit board PCB in its thickness direction, so as to span from the switching element SW34 to the capacitor C3G, an inductor L24 formed with a conductor pattern is arranged. At the far side of the reverse face of the printed circuit board PCB in its thickness direction, so as to span from the switching element SW44 to the capacitor C3H, an inductor L14 formed with a conductor pattern is arranged.

At one side of the switching element SW44 and the capacitor C3H along X direction, opposite the switching element SW44 and the capacitor C3H along X direction, a secondary-side driver DRV2B is formed. The secondary-side driver DRV2B drives the switching elements SW33, SW43, SW34, and SW44.

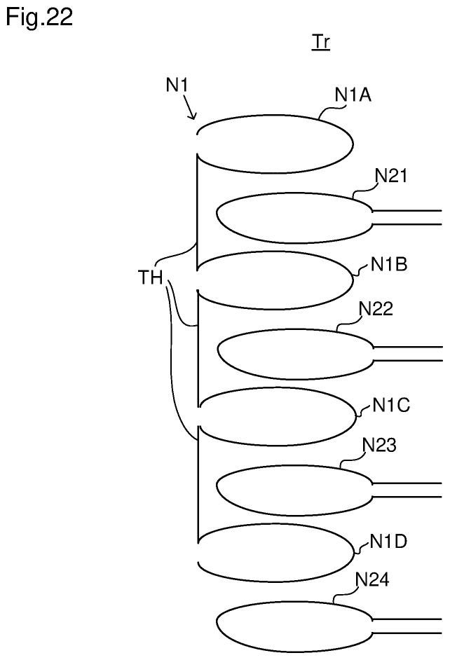

FIG. 22 is a schematic diagram showing one example of the transformer Tr formed with a conductor pattern. The vertical direction across the plane of FIG. 22 is the thickness direction of the printed circuit board PCB. In the example in FIG. 22, the switching power supply circuit has eight wiring layers in its thickness direction. In each of those wiring layers, a winding conductor is formed, identified by N1A, N21, N1B, N22, N1C, N23, N1D, and N24 respectively from one side in the thickness direction, each winding conductor corresponding to one turn of winding. Between every two adjacent wiring layers in the thickness direction, an insulation layer is arranged. Every two adjacent ones of the winding conductors N1A, N1B, N1C, and N1D conduct to each other via a through hole TH extending in the thickness direction. The winding conductors N1A, N1B, N1C, and N1D and the through hole TH constitute the primary winding N1. That is, in FIG. 22, the primary winding N1 has four turns of winding. On the other hand, the winding conductors N21 to N24 correspond to the secondary-side windings N21 to N24 respectively.

The transformer Tr configured as described above provides strong magnetic coupling between the primary and secondary sides.

### 11. Semiconductor Device

As any of the different switching elements in the switching power supply circuit according to the embodiment, for example, a semiconductor device as described below can be used.

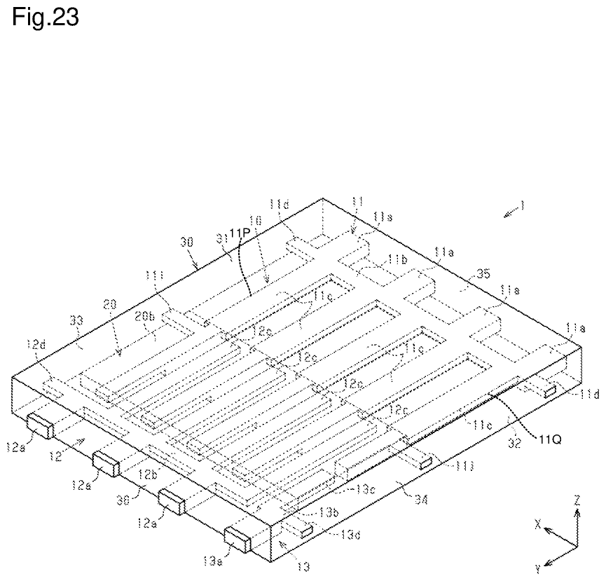

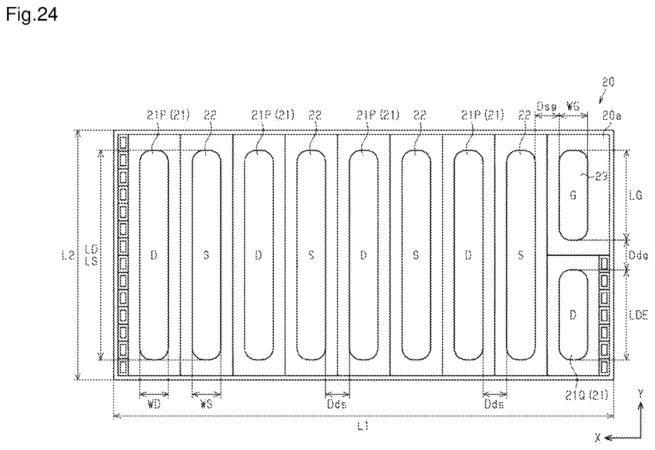

FIG. 23 is a perspective view of a semiconductor device. FIG. 24 is a plan view of a transistor in the semiconductor device shown in FIG. 23.

As shown in FIG. 23, the semiconductor device 1 has a lead frame 10 for electrical connection to a circuit board (not illustrated in FIG. 23), a transistor 20 mounted on the lead frame 10, and sealing resin 30 for sealing the transistor 20. The transistor 20 is a HEMT (high-electron-mobility transistor) using a nitride semiconductor. The semiconductor device 1 has a package (sealing resin 30) of which the dimension along a first direction X, that is, the lateral direction of the semiconductor device 1, is about 5 mm, of which the dimension along the second direction Y, that is, the longitudinal direction of the semiconductor device 1, is about 6 mm, and of which the dimension in the height direction Z of the semiconductor device 1 is about 0.6 mm. The semiconductor device 1 is of a surface-mount type, and of what is called an SOP (small outline package) type, in which the lead frame is lead out of the sealing resin 30 in two directions.

The use frequency range of the semiconductor device 1 is 1 MHz or higher but 100 MHz or lower, and preferably 1 MHz or higher but 30 MHz or lower. The semiconductor device 1 according to the embodiment is used at 30 MHz. The semiconductor device 1 can be used in circuits where the range of drain current is 1 A or higher but 200 A or lower, and should preferably be used in circuits where the range of drain current is 10 A or higher but 100 A or lower.

The sealing resin 30 is, for example, epoxy resin formed into a rectangular plate. The sealing resin 30 has, as its top face, an obverse face 31 and, as its bottom face, a reverse face 32 opposite from the obverse face 31 in the height direction Z. The reverse face 32 is for mounting on a circuit board. The sealing resin 30 has, as the side face at one side in the first direction X, a first lateral side face 33; as the side face at the other side in the first direction X, a second lateral side face 34; as the side face at one side in the second direction Y, a first longitudinal side face 35; and, as the side face at the other side in the second direction Y, a second longitudinal side face 36.

The transistor 20 is formed in the shape of a rectangular plate. As seen in a plan view, the transistor 20 has an elongate rectangular shape. The transistor 20 is mounted on the lead frame 10 with the longitudinal direction of the transistor 20 aligned with the first direction X. As shown in FIG. 24, the transistor 20 can be, for example, so sized in terms of external dimensions that, as seen in a plan view, the length L1 of one side in the longitudinal direction is about 4200 μm and the length L2 of one side in the other direction is about 2100 μm, so as to be in an elongate rectangular shape with an aspect ratio of 2:1. In the following description of the transistor 20, any direction mentioned is a direction with respect to the transistor 20 as it is mounted on the lead frame 10.

The transistor 20 has, as one face facing the lead frame 10 (see FIG. 23), an obverse face 20a and, as another face facing away from the obverse face 20a, a reverse face 20b (see FIG. 23). On the obverse face 20a, for electrical connection to the lead frame 10, there are provided five drain electrode pads 21, four source electrode pads 22, and one gate electrode pad 23. The drain electrode pads 21 include four drain electrode pads 21P that have a larger length LD in the longitudinal direction and one drain electrode pad 21Q that has a smaller length LDE in the longitudinal direction. It should be noted that there may be provided any number of drain electrode pads 21, any number of source electrode pads 22, and any number of gate electrode pads 23. Accordingly, for example, there may be provided different numbers of drain electrode pads 21 and source electrode pads 22. The transistor 20 may have a plurality of gate electrode pads 23. In the following description, the five drain electrode pads 21 will be collectively referred to as the drain electrode pads 21.

As shown in FIG. 24, as seen on a plan view, the drain electrode pads 21 and the source electrode pads 22 are arranged alternately in the longitudinal direction (first direction X) of the transistor 20. The drain electrode pads 21 and the source electrode pads 22 are each formed substantially in a rectangular shape elongate in the direction (second direction Y) orthogonal to the longitudinal direction of the transistor 20. The drain electrode pads 21 and the source electrode pads 22 are parallel to each other. Arranged at the opposite ends of the transistor 20 in the first direction X are drain electrode pads 21.

The gate electrode pad 23 is arranged at one end of the transistor 20 in the first direction X. The gate electrode pad 23 is located opposite, in the second direction Y, the drain electrode pad 21Q arranged at one end of the transistor 20 in the first direction X, with a gap left in between. The gate electrode pad 23 is arranged near one end of the transistor 20 in the second direction Y, and the drain electrode pad 21Q is arranged near the other end of the transistor 20 in the second direction Y.

The length LD of the four drain electrode pads 21P is equal to the length LS of the four source electrode pads 22. The length LDE of the drain electrode pad 21Q is equal to or less than one half of the length LD. The length LG of the gate electrode pad 23 is equal to the length LDE. The width WD of the drain electrode pads 21, the width WS of the source electrode pads 22, and the width WG of the gate electrode pad 23 are all equal. The drain electrode pads 21, the source electrode pads 22, and the gate electrode pad 23 all have their opposite end parts in the second direction Y formed into the shape of an arc convex in the second direction Y.

The drain electrode pads 21 are arranged at equal intervals in the first direction X, and the source electrode pad 22 are arranged at equal intervals in the first direction X. The four drain electrode pads 21P and the four source electrode pads 22 are arranged at the same position in the second direction Y. All distances Dds between a drain electrode pad 21 and the source electrode pad 22 adjacent to it in the first direction X are equal. The distance Dsg between the gate electrode pad 23 and the source electrode pad 22 adjacent to it in the first direction X is equal to the distance Dds.

The transistor 20 in FIG. 24 has the following internal dimensions. The length LD of the four drain electrode pads 21P and the length LS of the four source electrode pads 22 is about 1760 μm. The length LDE of the drain electrode pad 21Q is about 755 μm. The length LG of the gate electrode pad 23 is about 755 μm. The width WD of the drain electrode pads 21, the width WS of the source electrode pads 22, and the width WG of the gate electrode pad 23 are all about 240 μm.

The distance Ddg between the gate electrode pad 23 and the drain electrode pad 21Q in the second direction Y is about 250 μm. All distances Dds between a drain electrode pad 21 and the source electrode pad 22 adjacent to it in the first direction X are each about 200 The distance Dsg between the gate electrode pad 23 and the source electrode pad 22 adjacent to it in the first direction X is about 200 μm.

The lead frame 10 includes a drain frame 11 that is electrically connected to the drain electrode pads 21 (see FIG. 24), a source frame 12 that is electrically connected to the source electrode pads 22 (see FIG. 24), and a gate frame 13 that is electrically connected to the gate electrode pad 23 (see FIG. 24). The drain frame 11, the source frame 12, and the gate frame 13 are each formed by etching a sheet of copper. The drain frame 11, the source frame 12, and the gate frame 13 are arranged with a gap left between each other so as to be electrically isolated from each other.

As seen in a plan view, the drain frame 11 is arranged in a part of the sealing resin 30 near the first longitudinal side face 35. The drain frame 11 has four drain terminals 11a, a drain coupling 11b that connects together those drain terminals 11a, and five drain frame fingers 11c that extend from the drain coupling 11b toward the second longitudinal side face 36 in the second direction Y. The drain frame fingers 11c extend along the second direction Y. Thus the drain frame 11 is formed in the shape of comb teeth. The four drain terminals 11a, the drain coupling 11b, and the five drain frame fingers 11c are formed, for example, as a single member. There may be provided any number of drain terminals 11a and any number of drain frame fingers 11c. The number of drain terminals 11a and the number of drain frame fingers 11c may be equal or different. It is preferable that the number of drain frame fingers 11c be determined in accordance with the number of drain electrode pads 21 in the transistor 20 in FIG. 24.

As seen in a plan view, the drain terminals 11a are formed each in an elongate rectangular shape of which the longitudinal direction is aligned with the second direction Y. The drain terminals 11a are arranged at equal intervals in the first direction X. The drain terminals 11a are arranged at positions adjacent to the first longitudinal side face 35 of the sealing resin 30. End parts of the drain terminals 11a at one side in the second direction Y protrude from the first longitudinal side face 35 out of the sealing resin 30. End parts of the drain terminals 11a at the other side in the second direction Y are coupled to the drain coupling 11b.

At opposite end parts of the drain coupling 11b in the first direction X, there are formed, integrally with the drain coupling 11b, first tie bars 11d that couple the drain frame 11 to a steel sheet when the drain frame 11 is formed out of the steel sheet as a base material. The first tie bars 11d extend in the first direction X from the opposite end parts of the drain coupling 11b. One of the first tie bars 11d is formed to extend from the drain coupling 11b up to the first lateral side face 33. The other of the first tie bars 11d is formed to extend from the drain coupling 11b up to the second lateral side face 34.

The drain frame fingers 11c include four drain frame fingers 11P with a larger length in the second direction Y and a drain frame finger 11Q with a smaller length in the second direction Y.

The one nearest the first lateral side face 33 of the drain frame fingers 11P and the drain frame finger 11Q have formed on them second tie bars 11i and 11j. The second tie bar 11i extends from the middle of the sealing resin 30 in the second direction Y toward the first lateral side face 33 in the second direction Y. The second tie bar 11i provided on the drain frame fingers 11P is exposed out of the first lateral side face 33. The second tie bar 11j, formed on the drain frame finger 11Q, extends from the middle of the sealing resin 30 in the second direction Y toward the second lateral side face 34 in the second direction Y. The second tie bar 11j is exposed out of the second lateral side face 34.

As seen in a plan view, the source frame 12 is formed in a part of the sealing resin 30 near the second longitudinal side face 36. As seen in a plan view, the source frame 12 is formed in a part of the sealing resin 30 near the first lateral side face 33. The source frame 12 includes three source terminals 12a, a source coupling 12b that connects together those source terminals 12a, and four source frame fingers 12c that extend from the source coupling 12b toward the first longitudinal side face 35 in the second direction Y. The source frame fingers 12c extend along the second direction Y. Thus the source frame 12 is formed in the shape of comb teeth. The plurality of source terminals 12a, the source coupling 12b, and the plurality of source frame fingers 12c are formed, for example, as a single member. There may be provided any number of source terminals 12a and any number of source frame fingers 12c. For example, the number of source terminals 12a and the number of source frame fingers 12c may be equal or different. It is preferable that the number of source frame fingers 12c be determined in accordance with the number of source electrode pads 22 in the transistor 20 in FIG. 24.

As seen in a plan view, the source terminals 12a are formed each in an elongate rectangular shape of which the longitudinal direction is aligned with the second direction Y. The source terminals 12a are arranged at equal intervals in the first direction X. The source terminals 12a are arranged at positions adjacent to the second longitudinal side face 36 of the sealing resin 30. End parts of the source terminals 12a at one side int second direction Y protrude from the second longitudinal side face 36 out of the sealing resin 30. End parts of the source terminals 12a at the other side in the second direction Y are coupled to the source coupling 12b. The positions of the source terminals 12a in the first direction X coincide with the positions of the drain terminals 11a in the first direction X. The width of the source terminals 12a (the dimension of the source terminals 12a in the first direction X) is equal to the width of the drain terminals 11a.

In an end part of the source coupling 12b near the first lateral side face 33, there is formed a tie bar 12d that couples the source frame 12 to a steel sheet (not illustrated) when the source frame 12 is formed out of the steel sheet as a base material. The tie bar 12d extends from the end part of the source coupling 12b up to the first lateral side face 33 in the first direction X.

As seen in a plan view, the gate frame 13 is arranged in a part of the sealing resin 30 near the second longitudinal side face 36. As seen in a plan view, the gate frame 13 is arranged in a part of the sealing resin 30 near the second lateral side face 34. The gate frame 13 includes a gate terminal 13a, a gate coupling 13b, and a gate frame finger 13c. The gate frame 13 is arranged adjacent to the source frame 12 in the first direction X.

As seen in a plan view, the gate terminal 13a is formed in an elongate rectangular shape of which the longitudinal direction is aligned with the second direction Y. The gate terminal 13a is arranged at a position adjacent to the second longitudinal side face 36 of the sealing resin 30. An end part of the gate terminal 13a at one side in the second direction Y protrudes from the second longitudinal side face 36 out of the sealing resin 30. An end part of the gate terminal 13a at the other side in the second direction Y is coupled to the gate coupling 13b. The position of the gate terminal 13a in the first direction X coincides with the position of the one nearest the second lateral side face 34 of the drain terminals 11a. The width of the gate terminal 13a (the dimension of the gate terminal 13a in the first direction X) is equal to the width of the drain terminals 11a.

The gate coupling 13b couples together the gate terminal 13a and the gate frame finger 13c. The position of the gate coupling 13b in the second direction Y coincides with the position of the source coupling 12b in the second direction Y. In an end part of the gate coupling 13b near the second lateral side face 34, there is formed a tie bar 13d that couples the gate frame 13 to a steel sheet (not illustrated) when the gate frame 13 is formed out of the steel sheet as a base material. The tie bar 13d extends from the end part of the gate coupling 13b up to the second lateral side face 34 along the first direction X.

The gate frame finger 13c is arranged at the side of the gate coupling 13b opposite from the gate terminal 13a. The gate frame finger 13c extends in the second direction Y from an end part of the gate coupling 13b near the first lateral side face 33. The length of the gate frame finger 13c is smaller than the length of the source frame fingers 12c.

The position of the gate frame finger 13c in the first direction X coincides with the position of the drain frame finger 11Q in the first direction X. The gate frame finger 13c is parallel to the source frame fingers 12c. The gate frame finger 13c is arranged nearer the second longitudinal side face 36 than the drain frame finger 11Q is. That is, in the second direction Y, a tip end part of the gate frame finger 13c is located opposite a tip end part of the drain frame finger 11Q.

### 12. Modifications

While the present invention has been described by way of embodiments, these embodiments allow for various modifications without departure from the spirit of the present invention.

For example, in the switching power supply circuits according to the embodiments described above, the gate driving voltage may be variably controlled not only for the switching elements in the secondary side but also for those in the primary side.

Variable control of the gate driving voltage may be applied not only to switching power supply circuit of an isolated type but also to those of a non-isolated type; it may be applied to, for example, high-side and/or low-side switching elements in non-isolated buck DC-DC converters.

### INDUSTRIAL APPLICABILITY

The present invention finds applications in a variety of switching power supply circuits.

### REFERENCE SIGNS LIST

100, 100X, 100XA to 100XD switching power supply circuit

210 to 240 secondary-side circuit

310, 310A to 340A, 310B to 340B, 310C to 340C, 310D to 340D current detector

41 feedback controller

42, 421, 422 variable controller

42A, 421A, 422A reference voltage generator

43 variable controller

43A processor

RG, RG1, RG2 regulator

PP1, PP2 push-pull circuit

C1, C2 input capacitor

SW1 to SW4, SW31 to SW34, SW41 to SW44 switching element

Tr transformer

N1 primary winding

N2, N21 to N24 secondary winding

L1, L2, L11 to L14, L21 to L24 inductor

C3 output capacitor

R1 to R4, R11, R12, R21, R22, R31, R32, R41, R42 resistor

C4, C41, C42 capacitor

ER1, ER2, ER21, ER22 error amplifier

IS isolator

CP1, CP2 comparator

Dr1 to Dr4 driver

IV1, IV2 inverter

M1, M11, M12 output transistor

BP11, BP21 NPN transistor

BP12, BP22 PNP transistor

T31 to T34, T41 to T44 temperature detector

Z load

1. A switching power supply circuit comprising:
a switching element;
a detector configured to detect a physical quantity related to an output power of the switching power supply circuit; and
a variable controller configured to variably control a gate driving voltage for the switching element based on a result of detection by the detector.

2. The switching power supply circuit according to claim 1, wherein the detector is a current detector configured to detect as the physical quantity an output current passing from the switching power supply circuit to a load.

3. The switching power supply circuit according to claim 1, wherein the detector is a current detector configured to detect as the physical quantity a current passing through the switching element.

4. The switching power supply circuit according to claim 2, wherein the variable controller includes:
a reference voltage generator configured to generate a reference voltage based on a current detection signal output from the current detector; and
a regulator configured to output based on the reference voltage an output voltage used as the gate driving voltage.

5. The switching power supply circuit according to claim 4, wherein the reference voltage generator includes voltage division resistors configured to divide a voltage of the current detection signal.

6. The switching power supply circuit according to claim 4, wherein the reference voltage generator includes:
a first resistor having a first terminal fed with the current detection signal; and
a first capacitor having
a first terminal connected to a second terminal of the first resistor and
a second terminal fed with a ground potential.

7. The switching power supply circuit according to claim 4, wherein
the regulator includes:
an output transistor having
a first terminal fed with an input voltage and
a second terminal at which the output voltage appears;
a second resistor having a first terminal connected to the second terminal of the output transistor;
a third resistor having
a first terminal connected to a second terminal of the second resistor and
a second terminal fed with a ground potential; and
a first error amplifier having
a first input terminal connected to a connection node to which the second and third resistors are connected,
a second input terminal fed with the reference voltage, and
an output terminal connected to a control terminal of the output transistor.

8. The switching power supply circuit according to claim 4, further comprising:
a push-pull circuit configured
to be supplied with the output voltage as a supply voltage,
to be fed with an output of a driver, and
to output the gate driving voltage while switching levels thereof based on the output of the driver.

9. The switching power supply circuit according to claim 1, wherein
the detector is a temperature detector configured to detect as the physical quantity a temperature of the switching element.

10. The switching power supply circuit according to claim 9, wherein the variable controller includes:
a processor configured to calculate a conduction loss in the switching element based on a temperature detection signal output from the detector and the gate driving voltage.

11. The switching power supply circuit according to claim 1, wherein
the switching power supply circuit is of an isolated type, and
the switching element is arranged in a secondary side.

12. The switching power supply circuit according to claim 11, comprising:
a first input capacitor and a second input capacitor connected in series between an application terminal for a first input voltage and an application terminal for a ground potential;
a first switching element and a second switching element connected in series between the application terminal for the first input voltage and the application terminal for the ground potential;
a transformer having
a primary winding connected between
a first connection node to which the first and second input capacitors are connected and
a second connection node to which the first and second switching elements are connected, and
a secondary winding;
a first inductor having a first terminal connected to a first terminal of the secondary winding;
a second inductor having a first terminal connected to a second terminal of the secondary winding;
a third switching element having a first terminal connected to the first terminal of the second inductor;
a fourth switching element having a first terminal connected to the first terminal of the first inductor; and
an output capacitor having
a first terminal connected to a third connection node to which the second terminals of the first and second inductors are connected, and
a second terminal connected to the second terminals of the third and fourth switching elements.

13. The switching power supply circuit according to claim 12, wherein
the switching power supply circuit has a plurality of secondary-side circuits each including the secondary winding, the first and second inductors, and the third and fourth switching elements, and
the plurality of secondary-side circuits are connected in parallel.

14. The switching power supply circuit according to claim 12, wherein
the detector is a current detector arranged in a stage succeeding to the output capacitor.

15. The switching power supply circuit according to claim 12, wherein
the detector is a current detector configured to detect a current through each of the third and fourth switching elements.

16. The switching power supply circuit according to claim 13, wherein the detector includes a current detector for each of the secondary-side circuits.

17. The switching power supply circuit according to claim 16, wherein the current detector is arranged in a stage succeeding the third connection node,
the variable controller includes:
a reference voltage generator configured to generate a reference voltage based on a current detection signal output from the current detector; and
a regulator configured to output based on the reference voltage an output voltage used as the gate driving voltage, and
the reference voltage generator includes:
a first resistor having a first terminal fed with the current detection signal; and
a first capacitor having
a first terminal connected to a second terminal of the first resistor and
a second terminal fed with a ground potential.

18. The switching power supply circuit according to claim 12, wherein
the detector is a temperature detector configured to detect a temperature of each of the third and fourth switching elements.

19. The switching power supply circuit according to claim 12, wherein
the first, second, third, and fourth switching elements are formed by use of GaN (gallium nitride) as a semiconductor material.
